SEQUENCE LISTING (17 sequences)

SEQ ID NO: 1 - DNA, 133 bp, Artificial
  plasmid sequences
ttgttcctttctatgcggcccagccggccatggcaaagcttggatccgatatccatatggcctcgggggcctggactacaaagatgacgatgacaaaggcgcacaccatcaccatcaccattaataagaattc

SEQ ID NO: 2 - DNA, 133 bp, Artificial
  plasmid sequences
gaattcttattaatggtgatggtgatggtgtgcgcctttgtcatcgtcatctttgtagtccaggcccccgaggccatatggatatcggatccaagctttgccatggccggctgggccgcatagaaaggaacaa

SEQ ID NO: 3 - DNA, 160 bp, Artificial
  plasmid sequences
tcctaggtggcctcgggggcctggactacaaagatgacgatgacaaaggcgcacaccatcaccatcaccatactagtgggggcggaagtattcaacatttccgtgtcgcccttattcccttttttgcggcattttgccttcctgtttttgctcacccaga

SEQ ID NO: 4 - DNA, 160 bp, Artificial
  plasmid sequences
tctgggtgagcaaaaacaggaaggcaaaatgccgcaaaaaagggaataagggcgacacggaaatgttgaatacttccgcccccactagtatggtgatggtgatggtgtgcgcctttgtcatcgtcatctttgtagtccaggcccccgaggccacctagga

SEQ ID NO: 5 - protein, 8 aa, Artificial
  epitope tag
DYKDDDDK

SEQ ID NO: 6 - protein, 6 aa, Artificial
  epitope tag
HHHHHH

SEQ ID NO: 7 - protein, 22 aa, Artificial
  plasmid sequences
SIQHFRVALIPFFAAFCLPVFA

SEQ ID NO: 8 - DNA, 28 bp, Artificial
  primer sequence
actcttcctttttcaatattattgaagc

SEQ ID NO: 9 - DNA, 51 bp, Artificial
  primer sequence
gcttcaataatattgaaaaaggaagagtatgagccatattcaacgggaaac

SEQ ID NO: 10 - DNA, 28 bp, Artificial
  primer sequence
gaaaaactcatcgagcatcaaatgaaac

SEQ ID NO: 11 - DNA, 51 bp, Artificial
  primer sequence
gtttcatttgatgctcgatgagtttttctaactgtcagaccaagtttactc

SEQ ID NO: 12 - DNA, 25 bp, Artificial
  primer sequence
accgagctcgaattcactggccgtc

SEQ ID NO: 13 - DNA, 25 bp, Artificial
  primer sequence
gacggccagtgaattcgagctcggt

SEQ ID NO: 14 - DNA, 65 bp, Artificial
  primer sequence
attacgccaagctttggagccttttttttggagattttcaacgtgaaaaaattattattcgcaat

SEQ ID NO: 15 - DNA, 46 bp, Artificial
  primer sequence
cagtgaattcttagctagcactagtatggtgatggtgatggtgtgc

SEQ ID NO: 16 - DNA, 42 bp, Artificial
  primer sequence
caccatactagtgggggcggaagtattcaacatttccgtgtc

SEQ ID NO: 17 - DNA, 50 bp, Artificial
  primer sequence
gccagtgaattcttagcgcgctagcttaccaatgcttaatcagtgaggca

(19) United States
(12) Patent Application Publication
(10) Pub. No.: US 2006/0094062 A1
(43) Pub. Date: May 4, 2006

(54) Ultra high throughput capture lift screening methods

(75) Inventors: Herren Wu, Boyds, MD (US); Changshou Gao, Potomac, MD (US)

Correspondence Address: JOHNATHAN KLEIN-EVANS, ONE MEDIMMUNE WAY, GAITHERSBURG, MD, 20878, US

(73) Assignee: MEDIMMUNE, INC., Gaithersburg, MD (US)

(21) Appl. No.: 11/261,630

(22) Filed: Oct. 31, 2005

Related U.S. Application Data
(60) Provisional application No. 60/623,240, filed on Nov. 1, 2004.

(51) Int. Cl. C40B 40/10

(52) U.S. Cl. 435/7.1

(57) ABSTRACT

The present invention relates to a method for identification and isolation of binding molecules having a selective affinity for a ligand. More specifically, this invention provides a process for the ultra high throughput screening of binding molecules from expression libraries containing billions of independent clones without the biases and limitations of other high throughput screening methods such as panning. Additionally, the present invention provides a method for the production of expression libraries essentially free of clones encoding non-functional molecules.

### 1. CROSS REFERENCE TO RELATED APPLICATIONS

This application claims the benefit under 35 U.S.C. §119(e) of U.S. Provisional Application No.: 60/623,240 filed Nov. 1, 2004. The priority application is hereby incorporated by reference herein in its entirety for all purposes.

### 2. FIELD OF THE INVENTION

The present invention relates to a screening process for ultra high throughput selection of binding proteins (e.g., antibody fragments) from a large combinatorial library. The screening process disclosed herein provides for the first time a method for the rapid screening of very large libraries of binding proteins without the biases and limitations of other high throughput screening methods (e.g., panning). The present invention further relates to methods for the production of expression libraries of molecules (e.g., binding molecules) essentially free of clones encoding non-functional molecules.

### 3. BACKGROUND OF THE INVENTION

It is now possible to generate large expression libraries of binding molecules using combinatorial recombinant DNA technologies. This is especially true in the field of antibody engineering, where recombinant antibody libraries routinely contain more then 10⁹ unique clones. While the availability of large libraries of binding molecules has provided a nearly unlimited source of binders to almost any ligand, the development of screening methods for the efficient and rapid screening such diverse libraries has lagged behind. Conventional screening methods have relied on such laborious time consuming techniques such as FACS analysis and ELISA screening using 96-well plates. Even with the use of automated robotic machinery, something beyond the budget of most laboratories, these screening methods allow only a small fraction of the clones in a diverse library to be screened using these conventional techniques.

Surface display libraries allow for the enrichment of specific binding clones by subjecting the organism displaying the binding molecule (e.g., phage and yeast) to successive rounds of selection (panning) over an immobilized ligand (for reviews see, Trends Biotechnol 9: 408-414; Coomber, et al., 2002, Methods Mol Biol 178: 133-45, Kretzschmar et al., 2002, Curr Opin Biotechol 13: 598-602; Fernandez-Gacio, et al., 2003; Lee et al., 2003, Trends Biotechnol 21: 45-52; and Kondo, et al., 2004, Appl Microbiol Biotechnol 64: 28-40). While panning techniques allow for the rapid screening of very diverse libraries, the repetitive selection cycles of most panning approaches results in the diminution of diversity with a few dominant clones, generally those having the highest binding affinity (enrichment bias) or highest display efficiency (display bias) being isolated. Another drawback to panning methods is that they often result in the isolation of binding proteins that recognize only a single dominant epitope on a ligand. Furthermore, clones that have slower growth kinetics are quickly eliminated from the population during panning regardless of their binding properties (growth bias). Another limitation of surface display libraries is that they generally rely on the generation of a fusion between the binding molecule and a display molecule for targeting to the surface. Such fusions can result in a binding molecule with altered or even ablated binding specificity. In addition, panning requires the ligand to be immobilized which may alter the conformation of the ligand and/or mask preferred binding protein recognition sites resulting in the isolation of binding molecules that bind to a non-native state of the ligand or to less preferred sites. Thus, panning methods often result in a selection bias leading to the isolation of only a few clones with similar binding properties that may recognize irrelevant ligand sites while leaving behind numerous and potentially more useful clones.

Two general types of filter-based screening methods have been developed generically referred to as “capture lift,” which circumvent some of the limitations of surface display panning methods. These methods utilize expression libraries that can produce soluble binding molecules as opposed to displaying them on the surface. The first filter-based screening method uses filters coated with the desired ligands to capture expressed soluble binding molecules (see for example, Rodenburg, et al., 1998, Hybridoma 17: 1-8; de Wildt, et al., 2000, Nat Biotechnol 18: 989-994.; Giovannoni, et al., 2001, Nucl Acids Res 29: E27). The second filter-based screening method captures the expressed soluble binding molecules on a filter coated with a generic capture molecule that recognizes a common feature of the binding molecules (e.g., an endogenous or engineered epitope tag or inherent structural feature or property of the molecules), subsequently the captured binding molecules are probed with soluble ligand (e.g., Skerra, et al., 1991, Anal Biochem 196: 151-155; Watkins, et al., 1998, Anal Biochem 256: 169-177). Although these methods can reduce the complications of selection, growth and display biases they are still limited. The first method is still subject to limitations resulting from the use of an immobilized ligand, and both are relatively laborious methods that permit the exhaustive screening of only small expression libraries (diversity ˜10⁶ clones) (Wu, et al., 2002, Cancer Immunol Immunother 51: 79-90).

Another limitation of all current library screening methods is the quality of the expression libraries. Current methods for the generation of expression libraries utilize a variety of amplification and cloning techniques which produce artifacts resulting in library clones expressing nonfunctional molecules. For example, libraries generated using PCR and related techniques will contain numerous clones expressing nonfunctional molecules due to the inherent error rate of these DNA replication methods. For example, PCR methods have error rates from 1.6×10⁻⁶ to 1.1×10⁻⁴ errors per base pair (see, e.g., Lundberg et al., 1991 Gene 108:1-6, Tindall and Kunkel, 1988, Biochemistry 27:6008-13). Likewise, surface display libraries, which are generated by the fusion of polynucleotides encoding a population of molecules to a polynucleotide encoding a polypeptide for surface display, numerous clones (as many as two thirds depending on the methods utilized) will contain a polynucleotides ligated in a non-productive reading frame. While the clones containing such detrimental sequence artifacts may not produce functional molecules they usually generate a viable clone (e.g., a phage or bacteria) which must be screened thereby significantly increasing the total number of clones which must be screened to identify a desired molecule (e.g., binding molecule).

Thus, there is a real need for a library screening method that incorporates the high throughput feature of phage display while eliminating the complications that arise from the use of surface display fusion proteins, immobilized ligands, and the bias that arises due to multiple rounds of stringent selection. Such a screening method would avoid the surface-display of a binding molecule and allow the direct identification of clones that can express a binding molecule in soluble form. Ideally, such a screening method would allow for the rapid and exhaustive screening of even very large expression libraries (greater then 10⁹ clones). In addition, methods to generate expression libraries of molecules (e.g., binding molecules) essentially free of clones comprising detrimental sequence artifacts resulting in non-functional molecules (e.g., molecules having frame shift or stop codon mutations) would enhance the efficiency of any screening technique.

Citation or discussion of a reference herein shall not be construed as an admission that such is prior art to the present invention.

### 4. SUMMARY OF THE INVENTION

The present invention relates to a process for ultra high throughput screening of binding molecules from expression libraries containing billions of independent clones. The screening process comprises or alternatively consists essentially of: 1) expressing a large population of binding molecules from an expression library plated at high density, 2) immobilizing the population of expressed binding molecules on a solid support, 3) contacting the immobilized binding molecules with at least one ligand, 4) visualizing those ligands that have selectively bound to the immobilized binding molecules, and 5) isolating the clone(s) expressing the binding molecule(s) that recognize and bind to the at least one ligand. This screening process enables the screening of at least 1 billion binding molecule clones per person per day and allows one to overcome the numerous limitations of the current screening technologies. Additionally, this screening process does not require the use of expensive automated machinery.

In one embodiment, the binding molecules are soluble. In another embodiment, the ultra high throughput screening process (hereinafter the “screening process of the invention” or simply “screening process”) is used to screen libraries expressing binding molecules. In still another embodiment, the screening process is used to screen phage, bacterial or yeast libraries expressing binding molecules. In a specific embodiment the screening process is used to screen libraries expressing antibodies or fragments thereof. In another specific embodiment the screening process is used to screen libraries expressing receptor molecules. In still another specific embodiment the screening process is used to screen libraries expressing nucleotide-binding molecules.

In one embodiment, an expression library of binding molecules is plated at high density. In one embodiment, the expression library of binding molecules are plated at a density of greater then 10, or greater then 100, or greater then 1,000, or greater then 10,000, or greater then 100,000 binding molecule expressing clones per mm². In another embodiment, the binding molecule-expressing clones are plated at a density of between 1,000 and 15,000 clones per mm².

In one embodiment, the population of binding molecules is immobilized on a solid support. In particular the population of expressed binding molecules is selectively immobilized on a solid support through the specific interaction with an agent on the solid support. Such agents include but are not limited to, chemical compounds, tethers, linkers, and polypeptide binding domains. It is also contemplated that the inherent properties of the binding molecule may facilitate immobilization. For example, a hydrophobic domain of the binding molecules will allow them to be immobilized to a plastic support. Solid supports of the invention include but are not limited to membranes, plastics glass and coated glass.

In one embodiment, the ligand can be any molecule that can be selectively bound by a binding molecule including but not limited to, peptides, polypeptides, nucleic acid, carbohydrate, lipid, or organic compound. In another embodiment, the ligand is soluble. In still another embodiment, the ligand is fused to a detection domain. It is specifically contemplated that the detection domain will allow for the amplification of the detection signal (infra). Detection domains of the invention include but are not limited to, thioredoxin, BSA, leucine zipper, the Fc domain and fragments thereof. In certain embodiments, the ligand is fused to multiple detection domains. Additionally, it is contemplated that particular detection domains will also facilitate the formation of ligand-dimers (e.g., Fc domain and leucine zipper domain) which can increase the avidity of the ligand-binding molecule interaction and result in improved binding, specificity and/or sensitivity of the screening method.

In one embodiment, the ligand selectively bound to the immobilized binding molecules is detected. It is specifically contemplated that the bound ligand may be detected by direct or indirect methods. Direct detection of a ligand can be performed by numerous techniques including but not limited to, covalent modification of the ligand with a readily detectible moiety (e.g., radioactive label, enzyme for chromogenic detection). Indirect detection of a ligand can be performed by methods well known in the art including but not limited to, using a second molecule known to interact with the ligand (e.g., antibody). The second molecule is either itself detected direct or indirect methods.

In one embodiment, the binding molecule clone(s) that recognize and bind to the ligand is (are) isolated. It is specifically contemplated that the solid support can provide a template for the isolation of a subset of binding molecule clones that contains the binding molecule clone(s) that recognize and bind to the ligand. This smaller population can then be screened using a modification of the screening process of the invention. Modifications may comprise plating and/or immobilizing the subset of clones at a lower density. It is contemplated that the subset of clones is plated and/or immobilizing at a density low enough to allow a single clone to be isolated but high enough for each clone present in the subset to be represented on the solid support at least once. It is also contemplated that the subset of binding molecule clones that contains the binding molecule clone(s) that recognize and bind to the ligand may be screened by alternative methods known to one skilled in the art. Alternative methods include but are not limited to, ELISA assay and FACS analysis. It is specifically contemplated that one or more aspects of the method of the invention may be automated.

The present invention further relates to methods for the production of expression libraries (e.g., libraries of binding molecules) containing few clones expressing molecules comprising detrimental sequence artifacts (e.g., molecules having frame shift or stop codon mutations) which result in nonfunctional molecules. The methods for the production of expression libraries comprises or alternatively consists essentially of: 1) generating, in an expression vector, a library of clones comprising polynucleotides encoding molecules ligated to a polynucleotide encoding at least one selectable marker useful for the selection of clones expressing functional molecules, 2) growing the library of clones generated in (1) under conditions which select for clones expressing functional molecules, and optionally 3) subcloning the polynucleotides encoding functional molecules from the selected library of step (2) into an alternate vector useful for the identification and/or isolation of particular desired functional clones.

The methods for the production of expression libraries disclosed herein enables the production of expression libraries comprising few clones expressing molecules having detrimental sequence artifacts which result in nonfunctional molecules, thereby reducing the total number of clones to be screened. In one embodiment, the library production methods are used to generate expression libraries for screening in phage, bacterial, yeast, plant or mammalian systems.

In one embodiment, the molecules encoded and expressed by the library of clones includes any population of molecules from which the isolation of one or more single molecule is desired. In another embodiment, the method for the production of expression libraries (hereinafter the “library production method of the invention” or simply “library production method”) is used to generate a library expressing a population of binding molecules. In still another specific embodiment, the library production method is used to generate a library expressing a population of ligands. It is contemplated that an expression library may be generated to express any population of binding molecules and/or ligands disclosed herein.

In a specific embodiment the library production method is used to generate libraries expressing antibodies or fragments thereof. In another specific embodiment the library production method is used to generate libraries expressing receptor molecules. In still another specific embodiment the library production method is used to generate libraries expressing nucleotide-binding molecules.

To facilitate the elimination of clones encoding molecules having detrimental sequence artifacts which result in nonfunctional molecules the polynucleotides encoding molecules are ligated to a polynucleotide encoding at least one selectable marker. Numerous selectable markers are well known in the art including, but not limited to, drug resistance markers (e.g., herbicide and antibiotic resistance genes), metabolic/auxotrophic markers (e.g., genes for enzymes required for the production of an essential metabolite), screenable/purification markers (e.g., genes encoding an enzyme for chromogenic detection or purification domain). The library of clones are grown under conditions which selects for clones expressing molecules which do not have a detrimental sequence artifacts. It will be understood by one of skill in the art that the growth conditions used for selection of clone encoding a functional molecule will vary depending on the selectable marker utilized. For example, clones will be grown in the presence of the appropriate drug when a polynucleotide encoding a drug resistance gene is used for selection or clones will be grown in the absence of the appropriate metabolite when a polynucleotide encoding a metabolic gene is used for selection.

It is contemplated that the expression library generated and selected in steps (1) and (2) of the library production methods of the invention may be subcloned into an alternate vector useful for the screening of the library.

Expression libraries generated using the library production methods of the invention may be screening using numerous methods well known to one of skill in the art. In one specific embodiment, the screening process of the present invention is utilized.

### 5. BRIEF DESCRIPTION OF THE FIGURES

FIG. 1. Overview of the general scheme for the capture lift used. A filter coated with capture reagent and blocked was placed on a plate containing a phage-expressed scFv library in a bacterial lawn. The filter was lifted and sequentially incubated with biotin-labeled antigen, an avidin-enzyme conjugate and a development agent for detection. See Example 1 for experimental details.

FIG. 2. Overview of the general scheme for the generation of a human scFv Library. The variable heavy (V_{H}) and light (V_{L}) sequences are reverse transcribed, amplified and then joined by overlapping PCR. The resulting scFv genes are then ligated into a phage expression vector (see, 2B for cloning detail) and transformed into E. coli for screening. (A). See Example 1 for experimental details. Subcloning region (SEQ ID NOS.: 1-2) of the M13 phage expression vector used for the generation of the scFv library and expression in E. coli. (B)

FIG. 3. A photograph of several positive clone signals on a filter, from the first round of screening, containing ˜3820 clones/mm² (˜3×10⁷ pfu/filter). A portion of the filter has been photographed through a magnifying lens to enlarge the detail of the positive clones (indicated by the arrows)(A). A photograph, from the second round of screening, of positive clones on filters containing ˜10⁵ pfu/filters (B). A photograph of positive clones on a filter from the third round of screening (C).

FIG. 4. ELISA analysis of 24 independent clones isolated from a single library by ultra high throughput screening. Of the 24 clones isolated 22 specifically bound the EphA4-His antigen used for screening.

FIG. 5. Coomassie Blue Stain of Prepared Biotinylated MEDI-AAA (Fab)₂ for Isolation of Anti-Idiotype scFv Clones. Prepared Biotinylated MEDI-AAA (Fab)₂ (lanes A and D), unlabled MEDI-AAA (Fab)₂ (lanes B and E), and MEDI-AAA IgG (lanes C and G), were run separated by PAGE under non-denaturing (lanes A, B and C) or denaturing (lanes D, E, F and G) conditions. Lane G is SeeBlue2 Marker.

FIG. 6. Anti-idiotype scFv Clones Are Specific for the MEDI-AAA IgG CDRs. The relative binding activity of an anti-idiotype scFv expressing clone was tested (in several experiments) by ELISA against full length MEDI-AAA IgG, an unrelated IgG having a closely related light chain framework and an identical Fc region and BSA (Panel A). The anti-idiotype scFv was further tested against a commercial polyclonal antibody preparation and another unrelated IgG (Syn) having a dissimilar framework (Panel B). The anti-idiotype scFv clone showed robust binding to MEDI-AAA IgG while little binding to unrelated IgGs or BSA was seen.

FIG. 7. Plasmid Map of pUCKA. Any polynucleotide may be cloned with 3′-FLAG and His6 epitope tags as a fusion protein with the Ampicillin^{r} (β-lactamase gene) selection marker. Also present on the plasmid is the Kanamycin^{r} selection marker. Coding regions containing stop codons or frameshift mutations will not produce a protein encoding β-lactamase and the resulting clones will not be ampicillin resistant. The locations in which the V_{H} and V_{L} coding regions were cloned into the pUCKA vector to produce an scFv with 3′-FLAG and His6 epitope tags as a fusion protein with the Ampicillin^{r} selection marker are indicated.

FIG. 8. Detail of Cloning Region of pUCKA. The nucleotide sequence of the 3′-cloning region of the expression plasmid used for ampicillin selection (SEQ ID NOS.: 3-4). The FLAG and His6 epitope tag coding regions and amino acid sequences are also indicated (red and blue arrows respectively). The signal sequence of the β-lactamase gene responsible for ampicillin resistance is also shown.

FIG. 9. Plasmid Map of pMD102. The V_{H} and V_{L} coding regions from a selected library may be cloned in frame with 3′-FLAG and His6 epitope tags into pMD102 which contains all the necessary genes for phage expression of the scFv for screening by the high through put capture lifts method described in Examples 1 and 2 (see below).

### 6. DETAILED DESCRIPTION OF THE INVENTION

The present invention provides a rapid and efficient screening process for ultra high throughput screening of binding molecules from expression libraries containing billions of independent clones. This screening process is advantageous in that it enables the screening of at least 1 billion binding molecule clones per person per day. In addition, the screening process of the invention overcomes the limitations of the current high throughput screening technologies including but not limited to, growth bias, display bias, enrichment bias, as well as selection biases that arise from the use of immobilized ligand and binding molecule fusions. The screening process of the invention further provides methods to enhance the detection of the specific interaction between a binding molecule and its ligand. Furthermore, the screening process of the invention can be used to screen against multiple ligands. The screening process of the invention can therefore be applied to the discovery of specific binding molecules for use in the diagnosis and treatment of human diseases from very large libraries of binding molecules. Although particularly well suited for the screening of exceptionally large populations of binding molecules, the screening process of the invention can be utilized for the screening of both large and small populations of binding molecules. It is also specifically contemplated that one or more aspects of the screening process of the invention can be automated (e.g., the analysis of detection signals, incubations and washes).

The screening process comprises or alternatively consists essentially of: 1) expressing a large population of binding molecules from an expression library plated at high density, 2) immobilizing the population of expressed binding molecules on a solid support, 3) contacting the immobilized binding molecules with at least one ligand, 4) visualizing those ligands that have selectively bound to the immobilized binding molecules, and 5) isolating the clone(s) expressing the binding molecule(s) that recognize and bind to the at least one ligand.

In one embodiment the binding molecules are soluble. In another embodiment, the screening process is used to screen libraries expressing binding molecules. In still another embodiment, the screening process is used to screen phage, bacterial or yeast libraries expressing binding molecules. Libraries of binding molecules that can be screened using the screening process of the present invention include but are not limited to, libraries expressing antibodies or fragments thereof, libraries expressing receptor molecules, libraries expressing nucleotide binding molecules and libraries expression random peptides.

In one embodiment, an expression library of binding molecule clones is plated at high density. In a specific, the expression library clones are plated at a density of greater then 10, or greater then 100, or greater then 1,000, or greater then 10,000, or greater then 100,000 clones per mm². In another specific embodiment, the expression library clones are plated at a density of between 1,000 and 15,000 clones per mm².

In one embodiment, the population of expressed soluble binding molecules is immobilized on a solid support. It is specifically contemplated that the population of expressed soluble binding molecules is selectively immobilized on a solid support through the specific interaction with an agent on the solid support (e.g., an antibody, chemical compound). It is also contemplated that the inherent properties of the binding molecule population may facilitate immobilization. Solid supports of the invention include but are not limited to membranes, plastics glass and coated glass.

In one embodiment, the ligand can be any molecule that can be selectively bound by a binding molecule including but not limited to, peptides, polypeptides, nucleic acid, carbohydrate, lipid, or organic compound. In one embodiment, the ligand comprises a domain of a tyro sine kinase or a tyro sine kinase ligand. Contemplated tyro sine kinases and tyrosine kinase ligands include but are not limited to, receptor tyrosine kinases and non-receptor tyrosine kinases. In another embodiment, the ligand is soluble. In still another embodiment, the ligand is fused to a detection domain. It is specifically contemplated that the detection domain will allow for the amplification of the detection signal (infra). In certain embodiments, the ligand is fused to multiple detection domains. Additionally, it is contemplated that particular detection domains will also facilitate the formation of ligand-dimers which can increase the avidity of the ligand-binding molecule interaction and result in improved binding, specificity and/or sensitivity of the screening method.

In one embodiment, the ligand selectively bound to the immobilized binding molecules is detected. It is specifically contemplated that the bound ligand may be detected by direct or indirect methods. Direct detection of a ligand can be performed by numerous techniques including but not limited to, covalent modification of the ligand with a radioactive label or enzyme for chromogenic detection. Indirect detection of a ligand can be performed by methods well known in the art including, for example, using an antibody known to interact with the ligand which is itself detected by direct or indirect methods.

In one embodiment, the binding molecule clone(s) that recognize and bind to the ligand is (are) isolated. It is specifically contemplated that the solid support can provide a template for the isolation of a subset of binding molecule clones that contains the binding molecule clone(s) that recognize and bind to the ligand. This smaller population can then be screen using a modification of the screening process of the invention. Said modification comprising plating the subset of clones at a lower density. It is contemplated that the subset of binding molecule clones is plated at a density low enough to allow a single clone to be isolated but high enough for each clone present in the subset to be represented on the solid support at least once. It is also contemplated that the subset of clones that contains the clone(s) expressing the binding molecule(s) that recognize and bind to the ligand may be screened by alternative methods known to one skilled in the art. Alternative methods include but are not limited to, ELISA assay and FACS analysis. It is also specifically contemplated that one or more aspects of the screening process of the invention can be automated. For example, incubation and wash steps used to eliminate non-specific interactions are routinely automated using readily available commercial equipment (e.g., The Stovall Washing Machine, cat. no. WMAA115S, Stovall Life Sciences Inc, Greensboro, N.C.), the analysis of signals on a solid support can also be readily automated (e.g., The Proteome Works Plus Spot Cutter cat. no. 165-7064, Bio-Rad Laboratories Inc., Hercules, Calif.).

The present invention also provides methods for the production of expression libraries of molecules (e.g., binding molecules) essentially free of clones encoding molecules having a detrimental sequence artifacts resulting in nonfunctional molecules. Detrimental sequence artifacts which may result in the expression of nonfunctional molecules includes, but are not limited to, molecules comprising premature stop codons, deletions, insertions, frameshift mutations, nonsense mutations and missense mutations. Accordingly, as used herein the term “nonfunctional molecule(s)” includes, but is not limited to, molecules comprising such detrimental sequence artifacts (e.g., premature stop codons, frameshift mutations, nonsense mutations and missense mutations). Clones expressing nonfunctional molecules are also referred to herein as “nonfunctional clones.” Nonfunctional clones are generally viable and thus represent a negative clone which must be eliminated by the screening process. The presence of nonfunctional clones may greatly increase the total number of library clones which must be screened in order to identify a desired clone. The methods for the production of expression libraries (hereinafter the “library production method(s) of the invention” or simply “library production method(s)”) provided herein is advantageous in that it enables the production of expression libraries comprising few, if any, clones expressing nonfunctional molecules thereby reducing the total number of clones to be screened.

In one embodiment, the method for the production of expression libraries comprises or alternatively consists essentially of: 1) generating, in an expression vector, a library of clones comprising polynucleotides encoding molecules ligated to a polynucleotide encoding at least one selectable marker useful for the selection of clones expressing functional molecules, 2) growing the library of clones generated in (1) under conditions which select for clones expressing functional molecules, and optionally 3) subcloning the polynucleotides encoding functional molecules from the selected library of step (2) into an alternate vector useful for the identification and/or isolation of particular desired functional clones.

It is contemplated that the polynucleotides encoding molecules are individually ligated to a to a polynucleotide encoding at least one selectable marker. However, one of skill in the art will recognize that multiple polynucleotides encoding molecules may be ligated to a single polynucleotide encoding at least one selectable marker in a linear fashion.

It is contemplated that the expression library generated and selected using the library production methods of the invention may be in an expression vector which is useful for screening said selected library. However, it is also contemplated that an expression library may be generated and selected in an expression vector useful for the generation and selection of said library but not for screening of said generated and selected library. Accordingly, in one embodiment, the expression library generated and selected using the library production methods of the invention is subsequently subcloned into an alternate vector useful for the screening of the library.

Accordingly, in one specific embodiment, the library production method comprises: 1) generating, in an expression vector, a library of clones comprising polynucleotides encoding molecules ligated to a polynucleotide encoding at least one selectable marker useful for the selection of clones expressing functional molecules, and 2) growing the library of clones generated in (1) under conditions which select for clones expressing functional molecules.

In another specific embodiment, the library production method comprises: 1) generating, in an expression vector, a library of clones comprising polynucleotides encoding molecules ligated to a polynucleotide encoding at least one selectable marker useful for the selection of clones expressing functional molecules, 2) growing the library of clones generated in (1) under conditions which select for clones expressing functional molecules, and 3) subcloning the polynucleotides encoding functional molecules from the selected library of step (2) into an alternate vector useful for the identification and/or isolation of particular desired functional clones.

Vectors useful for the screening of expression libraries are well known in the art and described below (see, e.g., Section entitled “Expression Libraries and Expression Vectors”), specific vectors useful for steps (1) and (2) and step (3) of the library production methods of the invention are detailed in Examples 3-5 (infra). In a specific embodiment, the polynucleotides encoding functional molecules from the generated and selected library are subcloned into a phage expression vector.

The library production methods of the invention may be utilized for the generation of a variety of expression libraries for use in different systems. In one embodiment, the library production methods of the invention are used to generate expression libraries for screening in systems including, but not limited to, phage, bacterial, yeast, plant and mammalian systems. Expression libraries generated using the library production method of the invention may be screening using numerous methods well known to one of skill in the art. In a specific embodiment, the screening process of the present invention is utilized.

In one embodiment, the polynucleotides encoding molecules encodes a population of molecules. In another embodiment, the polynucleotides encodes a population of molecules from which the isolation of one or more single molecule is desired. For example, an expression library may be generated from the entire population of messenger RNAs expressed by a cell, tissue or organism. Alternatively, an expression library may be generated from polynucleotides encoding a population of molecules having a particular characteristic, such as for example, a desired amino acid motif. It is contemplated that the polynucleotides encoding a population of molecules may be isolated or derived from a natural source (e.g., messenger RNAs isolated from a cell) or may be generated de novo (e.g., polynucleotide sequences encoding random polypeptides). In one embodiment, the library production method of the invention is used to generate an expression library expressing a population of binding molecules. In another embodiment, the library production method is used to generate an expression library expressing a population of ligands. In yet another embodiment, the library production method is used to generate an expression library expressing any population of binding molecules and/or ligands disclosed herein.

In a specific embodiment the library production method is used to generate libraries expressing a population of antibodies or fragments thereof. In another specific embodiment the library production method is used to generate libraries expressing a population of receptor molecules or fragments thereof. In still another specific embodiment the library production method is used to generate libraries expressing a population of nucleotide-binding molecules or fragments thereof. In yet another specific embodiment the library production method is used to generate libraries expressing a population of random polypeptides.

To facilitate the elimination of clones encoding nonfunctional molecules the polynucleotides encoding molecules are ligated to a polynucleotide encoding at least one selectable marker. Numerous selectable markers are well known in the art including, but not limited to, drug resistance markers (e.g., herbicide and antibiotic resistance genes), metabolic/auxotrophic markers (e.g., genes for enzymes required for the production of an essential metabolite), screenable/purification markers (e.g., genes encoding an enzyme for chromogenic detection or purification domain). The library of clones are then grown under conditions which select for clones expressing functional molecules. It will be understood by one of skill in the art that the growth conditions utilized will vary depending on the selectable marker utilized. For example, clones will be grown in the presence of the appropriate drug when a polynucleotide encoding a drug resistance gene is used for selection or clones will be grown in the absence of the appropriate metabolite when a polynucleotide encoding a metabolic gene is used for selection.

It is further contemplated that the polynucleotides encoding molecules are ligated to a polynucleotide encoding at least one epitope tag sequence (also referred to herein as “marker” sequences or simply as “tag” sequences) useful for immobilization and/or detection in addition to being ligated to a polynucleotide encoding at least one selectable marker. Numerous marker and/or tag sequences are known in the art, for example, but not by way of limitation, the hexa-histidine peptide, the hemagglutinin “HA” tag, and the “flag” tag. Additional details regarding these tags and methods useful for the incorporation of such tag can be found below in the sections entitled “Binding Molecules” and “Examples.”

### 6.1 Expression Libraries and Expression Vectors

General methods for the generation of expression libraries are well known in the art and available from numerous sources including, for example, Current Protocols in Molecular Biology, F. M. Ausubel et al., ed., John Wiley & Sons (Chichester, England, 1998), Chapters 5 and 6. Specific examples of general methods for constructing cDNA expression libraries include Chen et al., Nature (1995) 377:428-431, Akopian et al., Nature (1996) 379:257-262, which describe suitable methods for generating a cDNA expression library from polyadenylated RNA. Random peptide libraries are reviewed in Hruby et al., 1997, Curr Opin Chem Biol 1:483-490, whole genome expression libraries are described, for example, in Preuss et al., 2002, Immunol Rev 188: 43-50 and libraries of nucleic acids and small molecule compounds are reviewed in Gray, 2001, Curr Opin Neurobiol 11:608-614.

Expression libraries expressing a population of molecules, such as those described infra, can be constructed in an appropriate expression vector, such as those disclosed herein (see Examples 3-5). In a specific embodiment, the library production method of the invention comprises a first step of generating, in the expression vector pUCKA, a library of clones comprising polynucleotides encoding molecules ligated to a polynucleotide encoding at least the β-lactamase gene. Accordingly, the present invention provides the expression vector pUCKA useful the production and selection of a library of expression clones. Key features of pUCKA include, two drug selection markers: a kanamycin resistance gene for selection/maintenance of cells containing the vector and a β-lactamase gene (provides ampicillin/carbenicillin resistance) for selection to remove clones expressing nonfunctional molecules, an origin of replication, a promoter and signal sequence 5′ of a cloning site (Sfi I) and 3′ of the cloning site are a FLAG and HIS6 epitope tags ligated in frame to the β-lactamase gene. It would be understood by one skilled in the art, based upon the disclosure provided herein, that variants of pUCKA and other alternative expression vectors could be generated (see, e.g., Examples 3 and 5) and/or utilized in library production method of the present invention. In another embodiment, the present invention provides a variant of pUCKA comprising changes in one or more of the following features, epitope tags, cloning sites for insertion of polynucleotides encoding a library of molecules, selection marker for fusion of polynucleotides encoding a library of molecules, origin of replication, signal sequences, promoters, additional selection marker for maintenance/selection of cells comprising an expression vector, addition of other specialized components necessary for expression and/or maintenance of the vector in a cell.

Other vectors are readily available and well known to those skilled in the art. An expression vector useful in the methods of the present invention will contain an appropriate expression control sequence(s) (promoter) to direct RNA synthesis. For example, bacterial promoters include lacI, lacZ, T3, T7, gpt, lambda P_{R}, P_{L} and trp. Eukaryotic promoters include CMV immediate early, HSV thymidine kinase, early and late SV40, LTRs from retrovirus, and mouse metallothionein-I. Selection of the appropriate expression vector and promoter is well within the level of one of ordinary skill in the art. The expression vector may also contain a ribosome binding site for translation initiation and a transcription terminator. The vector may also include appropriate sequences for amplifying expression. In addition, the expression vectors may further contain a polynucleotide encoding selectable marker gene to provide a phenotypic trait for selection of transformed host cells comprising said expression vector. Some examples of selectable markers include dihydrofolate reductase or neomycin resistance for eukaryotic cell culture, or tetracycline or ampicillin resistance in E. coli. It will be understood by one skilled in the art that in addition to the selectable marker required for selection and/or maintenance of a transformed host cell comprising a library clone, a second selectable marker may be required for selection of those clones expressing functional clones.

Representative examples of expression vectors which may be used include, but are not limited to, viral particles, baculovirus, phage, plasmids, phagemids, cosmids, fosmids, bacterial artificial chromosomes, viral DNA (e.g. vaccinia, adenovirus, foul pox virus, pseudorabies and derivatives of SV40), P1-based artificial chromosomes, yeast plasmids, yeast artificial chromosomes, and any other vectors specific for specific hosts of interest (such as E. coli., bacillus, aspergillus, insect, plant, yeast, mammalian cells, etc.). Such vectors include chromosomal, nonchromosomal and synthetic DNA sequences. Large numbers of suitable vectors are known to those of skill in the art, and are commercially available. The following vectors are provided by way of example; Bacterial/Phage: pQE vectors (Qiagen), pBluescript plasmids, pNH vectors, Lambda DASH® II vectors, pTRG XR, ZAP vectors (Stratagene); ptrc99a, pKK223-3, pDR540, pRIT2T (Pharmacia); Eukaryotic: pXT1, pSG5, pCMV-Script® (Stratagene), pSVK3, pBPV, pMSG, pSVLSV40 (Pharmacia). However, any other plasmid or other vector may be used as long as they are replicable and viable in the host. Generally, recombinant expression vectors will include origins of replication appropriate for one or more host. It will be understood by one skilled in the art, based on the current disclosure, that an appropriate expression vector (e.g., one comprising a promoter to drive expression and a selectable marker for selection) may be generated by modifying a commercial vector, or generated de novo by combining the appropriate components required for replication, maintenance, expression, selection and other desired traits, as described herein.

Thus, a library of polynucleotides encoding molecules ligated to a polynucleotide encoding a selectable marker useful for the selection of clones expressing functional molecules may be generated in a variety of expression vectors useful for expressing a molecule.

### 6.2 Binding Molecules

As used herein the term “binding molecule(s)” is intended to refer to any molecule of sufficient size and complexity as to be capable of selectively binding a ligand. Such molecules are generally macromolecules including but not limited to polypeptides, nucleic acids, carbohydrates and lipids. However it is specifically contemplated that derivatives, analogues and mimetic compounds as well as small organic compounds are also intended to be included within the definition of this term. The size of a binding molecule is not important so long as the molecule exhibits or can be made to exhibit selective binding to a ligand.

As used herein the terms “selective” and “selectively” when referring to the binding of a binding molecule to a ligand as used herein refers to an interaction that can be discriminated from unwanted or non-specific interactions. Discrimination can be based on, for example, affinity or avidity and can be derived from multiple low affinity interactions or a small number of high affinity interactions. High affinity interaction are generally greater then about 10⁻⁸ M to about 10⁻⁹ M or greater.

In one embodiment, a binding molecule will bind to a ligand with an affinity of greater then about 10⁻⁴ M. In another embodiment, a binding molecule will have an affinity for a ligand that is greater then about 10⁻⁴ M, or about 10⁻⁵ M, or about 10⁻⁶ M, or about 10⁻⁷ M, or about 10⁻⁸ M, or about 10⁻⁹ M, or about 10⁻¹⁰ M.

Binding molecules can include, for example, antibodies and other receptor or ligand binding polypeptides of the immune system including but not limited to, T cell receptors (TCR), major histocompatibility complex (MHC), CD4 receptor, and CD8 receptor, other CD molecules including but not limited to CD2, CD3, CD19, CD20, CD22, etc. Other binding molecules specifically contemplated include but are not limited to, cell surface receptors, (e.g., integrins, growth factor receptors and cytokine receptors), cytoplasmic receptors (e.g., steroid hormone receptors), DNA binding polypeptides (e.g., transcription factors and DNA replication factors). Binding molecules also includes variants of said binding molecules and/or fusion molecules containing a portion of said binding molecule most likely to contribute to ligand binding. Additionally, binding molecule populations such as those selected from random and combinational libraries (e.g., polypeptides, nucleic acids, aptamers and chemical compounds) are also contemplated so long as such a molecule exhibits or can be made to exhibit selective binding activity toward a ligand.

The choice of binding molecule population will depend on the type of binding molecule(s) desired, the need and the intended use of the final selected binding molecule(s). One approach is to generate binding molecule populations from molecules known to function as binding molecules or known to exhibit or be capable of exhibiting binding activity. For example, antibodies and other receptors of the immune repertoire are known to function as binding molecules that can bind essentially an infinite number of different antigens and ligands. Therefore, generating a diverse population of binding molecules from an antibody repertoire, for example, will allow the identification of a binding molecule against essentially any desired ligand.

A second approach is to generate a large population of unknown molecules. The population should be generated to contain a sufficient diversity of sequence or structure so as to contain a molecule that will bind to the ligand composition of interest. An advantage of this approach is that no prior knowledge of sequence, structure or function is required. Instead, all that is necessary is to generate a population of sufficient size and complexity so that the population will have a high probability of exhibiting a specific binding interaction to the ligand complex by chance. Specific examples of such a population are random libraries of peptides, nucleic acids and small molecule compounds. Those skilled in the art will know or can determine what type of approach and what type of binding molecule population is applicable for an intended purpose and desired need.

The size and diversity of the binding molecule population used will be determined by several factors including but not limited to, the ligand population or composition, the range of desired affinities, the complexity of the binding molecule, as well as the number and type of binding molecules desired. As the desired number of binding molecules to be identified increases, so does the size and diversity of the population of binding molecules. Similarly, when a library of binding molecule variants (e.g., antibodies or fragments thereof) is to be screened, the size of the population increases with the complexity of the binding molecule itself. Moreover, the size of the population of binding molecules will likewise increase as the number or complexity of the ligand increases.

Small sized populations will consist of hundreds and thousands of different binding molecules, moderate sized populations will consist of tens and hundreds of thousands whereas as large populations will consist of millions and billions of different binding molecules. While the screening process of the present invention can be used to screen any size population of binding molecules, it is uniquely suited for the screening of large and diverse populations consisting of millions and billions of different binding molecules, specifically those populations containing any of about 10⁶, 10⁷, 10⁸, 10⁹, 10¹⁰, 10¹¹ or more different binding molecules. Likewise, the library production methods of the invention can be used to generate libraries of any size population of molecules however, they are well suited for the generation of expression libraries of large and diverse populations consisting of millions and billions of different molecules, specifically populations of molecules containing any of about 10⁶, 10⁷, 10⁸, 10⁹, 10¹⁰, 10¹¹ or more different molecules. One skilled in the art will know the approximate diversity of the population of binding molecules which will be sufficient to screen and/or identify the desired number of binding molecules.

Recombinant libraries of binding molecules are generally utilized because large and diverse populations of binding molecules can be rapidly generated. Recombinant methods allow for the production of a large number of binding molecule populations from naturally occurring repertoires which inherently contain features for selective immobilization of the population to a solid support. Furthermore, recombinant libraries of expressed polypeptides or nucleic acid can be engineered in a large number of ways to facilitate or directly function in the selective immobilization of the binding molecule population to a solid support. It is specifically contemplated that the library production methods of the invention may be utilized for the production libraries of binding molecules.

Populations of binding molecules can be produced or derived from essentially any source so long as the population is sufficiently diverse so that there is a very likely probability that the population contains at least one binding molecule that selectively binds to the desired ligand. Populations of binding molecules can be generated from molecules known to function as binding molecules or exhibit binding activity, such molecules include but are not limited to antibodies, fragments thereof, other receptors of the immune system, receptors, nucleotide binding proteins and lectins. Alternatively, a population of binding molecules can be generated from unknown molecules, for example, random peptide libraries (reviewed in Hruby et al., 1997, Curr Opin Chem Biol 1:483-490), whole genome expression libraries (e.g., Preuss et al., 2002, Immunol Rev 188: 43-50), nucleic acids and small molecule compounds (reviewed in Gray, 2001, Curr Opin Neurobiol 11:608-614).

The choice of the binding molecule population will depend on the type of binding molecule desired. For example, if high affinity binding molecules are desired, then a population of antibody binding molecules may be utilized. Similarly, binding molecule populations may be derived from other molecules of the immune system that exhibit a similar level of heterogenicity (e.g., T-cell receptors and the major histocompatibility complex receptors CD4 and CD8). The normal function of these of such molecules is to bind essentially an infinite number of different antigens and/or ligands (Kuby, J. (ed), 1997, Immunology, Third Ed., New York, W.H. Freeman & Co.). Therefore, generating a diverse population of binding molecules from these molecules will allow the identification of a binding molecule against essentially any desired ligand.

It is specifically contemplated that binding molecules with a particular biological effect may be identified from a population of binding molecules. For example, a binding molecule may be an antagonist capable of inhibiting one or more of the biological activities of a target molecule. Antagonists may act by interfering with the binding of a receptor to a ligand and vice versa, by incapacitating or killing cells which have been activated by a ligand, and/or by interfering with receptor or ligand activation (e.g. tyrosine kinase activation) or signal transduction after ligand binding to a cellular receptor. The antagonist may completely block receptor-ligand interactions or may substantially reduce such interactions. Alternatively, a binding molecule may be an agonist capable of activating one or more of the biological activities of a target molecule. Agonists may, for example, act by activating a target molecule and/or mediating signal transduction. Assays to determine a biological effect of a binding molecule are well known to one skilled in the art.

Other binding molecules exhibiting known or inherent binding functions which are amenable for the generation of an expression library using the library production methods of the present invention or for use as starting populations in the screening process of the invention include a variety of receptors including but not limited to, cell surface, cytoplasmic and nuclear receptors. Examples of cell surface receptors include but are not limited to receptors for, extracellular matrix components (e.g., integrins), growth factors (e.g., EGFR, FGFR), hormones, insulin and insulin-like proteins (IR, IGF-Rs), cytokines (e.g., IL-4R, IL-13), receptor tyrosine kinases (e.g., ALK, EphA2, EphA3, EphA4, EphA5, EphA6, EphA7, EphA8, EphB1, EphB2, EphB3, EphB4, EphB5, EphB6), cytokines (e.g., IFNAR) and chemokines (e.g., CXC-Rs, CC-Rs). Exemplary examples of cytoplasmic and nuclear receptors (for review see, Mangelsdorf et al, 1995, Cell 83:835) includes but is not limited to, steroid hormone receptors (Kumar et al., 1999, Steroids 64:310), PPAR receptors (Wilson et al., 2000, J Med Chem 43:527), vitamin receptors, and nucleic acid binding proteins (de Miguel, et al., 1998, Curr Opin Chem Biol 2:417-421; and McEwan, I. (ed), 2004, Essays in Biochemistry, Volume 40, London, Portland Press Ltd.).

It also specifically contemplated that binding molecule libraries may be derived from random libraries of unknown sequences or structures. Such libraries can be readily generated using standard recombinant techniques known in the art (reviewed in, Lebl, et al., 1997, Methods Enzymol 289:336-392 and Shusta, et al., 1999, Curr Opin Biotechnol 10:117-122).

In a specific embodiment, the population of binding molecules further incorporates a heterologous polypeptide fused or conjugated to the binding molecules. Heterologous polypeptides includes but is not limited to marker and/or tag sequences that are useful for immobilization and/or detection. For example, the hexa-histidine peptide, such as the tag provided in a pQE vector (QIAGEN, Inc., 9259 Eton Avenue, Chatsworth, Calif., 91311), among others, many of which are commercially available, are useful for both detection and immobilization (Gentz et al., 1989, Proc. Natl. Acad. Sci. USA 86:821-824). Other peptide tags useful for both detection and immobilization include, but are not limited to, the hemagglutinin “HA” tag, which corresponds to an epitope derived from the influenza hemagglutinin protein (Wilson et al., 1984, Cell 37:767) and the “flag” tag. Polypeptides, proteins and fusion proteins can be produced by standard recombinant DNA techniques or by protein synthetic techniques, e.g., by use of a peptide synthesizer. For example, a nucleic acid molecule encoding a peptide, polypeptide, protein or a fusion protein can be synthesized by conventional techniques including automated DNA synthesizers. Alternatively, PCR amplification of gene fragments can be carried out using anchor primers which give rise to complementary overhangs between two consecutive gene fragments which can subsequently be annealed and reamplified to generate a chimeric gene sequence (see, e.g., Current Protocols in Molecular Biology, F. M. Ausubel et al., ed., John Wiley & Sons (Chichester, England, 1998) and Molecular Cloning: A Laboratory Manual, 3rd Edition, J. Sambrook et al., ed., Cold Spring Harbor Laboratory Press (Cold Spring Harbor, N.Y., 2001)).

In another embodiment, the population of binding molecules further incorporates a biotin and/or hapten molecule tag, which are useful for both detection and immobilization. A population of binding molecules can be biotinylated (see, Diamandis et al., 1991, Clin Chem 37:625-636 for review of biotin tags in biotechnology) and/or haptenylated (see, chapter 4 of Molecular Probes: Handbook of Fluorescent Probes and Research Chemicals, R. P. Haugland, 9th ed., Molecular Probes, (Eugene Oreg., 2004) for overview of haptens and methods).

In one embodiment, the population of binding molecules is soluble. Some binding molecules are inherently soluble while others may require additional manipulations including but not limited to the introduction of additional components to solubilize them (e.g., detergents, chaotropic agent). It is specifically contemplated that the use of a soluble binding molecule population will facilitate screening by preventing the formation of insoluble binding molecule aggregates that may not be capable of interacting with a solid support and/or a ligand. In the case where a native binding molecule is desired it is contemplated that the population of binding molecules is inherently soluble as the manipulations required to solubilize molecules can result in conformational alterations leading to the identification of binding molecules that do not recognize a ligand in their native state.

Numerous methods exist for the production of soluble molecule from recombinant expression libraries. Methods include but are not limited to, fusion to a soluble protein (see below, section entitled “Ligands and Detection”) utilization of signal sequences for the specific secretion of expressed polypeptide from the host organism and the use of lysogenic phage expression libraries which cause bacterial lysis resulting in the release of bacterially produced polypeptides sequence (see, e.g., Current Protocols in Molecular Biology, F. M. Ausubel et al., ed., John Wiley & Sons (Chichester, England, 1998) and Molecular Cloning: A Laboratory Manual, 3rd Edition, J. Sambrook et al., ed., Cold Spring Harbor Laboratory Press (Cold Spring Harbor, N.Y., 2001)). Those skilled in the art will know or can determine what type of library is applicable for a specific purpose.

In one embodiment, the library production methods of the invention are used to generate recombinant phage, bacterial or yeast libraries expressing soluble binding molecules. In another embodiment, the screening process is used to screen recombinant phage, bacterial or yeast libraries expressing soluble binding molecules. Specific examples of phage recombinant libraries include those in which lysogenic phage cause the release of bacterially expressed binding polypeptides and those in which the binding molecules are secreted into the periplasmic space without lysis of the cell.

In a specific embodiment, the library production methods are used to generate libraries expressing antibodies or fragments thereof. In another specific embodiment, the screening process is used to screen libraries expressing antibodies or fragments thereof. Libraries expressing antibodies or fragments thereof can be generated by a variety of means known to those skilled in the art included those disclosed herein. For example the polymerase chain reaction (PCR) can be used to amplify essentially the entire antibody repertoire of a particular organism and express it as a recombinant population a diverse combination of the heavy and light antibody chains, functional fragments thereof or as fusion proteins. For a specific method see Example 1, infra. Functional fragments of antibodies include but are not limited to, Fab, Fv, scFv, and CDR regions. In particular, antibodies include immunoglobulin molecules and immunologically active fragments of immunoglobulin molecules, i.e., molecules that contain an antigen binding site, these fragments may or may not be fused to another immunoglobulin domain including but not limited to, an Fc region or fragment thereof. The skilled artisan will further appreciate that other fusion products may be generated including but not limited to, scFv-Fc fusions, variable region (e.g., VL and VH)—Fc fusions and scFv-scFv-Fc fusions. Immunoglobulin molecules can be of any type (e.g., IgG, IgE, IgM, IgD, IgA and IgY), class (e.g., IgG1, IgG2, IgG3, IgG4, IgA1 and IgA2) or subclass.

It is specifically contemplated that the library production methods of the present invention may be used to generate libraries expressing populations of antibody molecules that are monspecific, bispecific or of greater multispecificity. It is also specifically contemplated that the screening process of the present invention may be used to screen populations of antibody molecules that are Nonspecific, bispecific or of greater multispecificity. See, e.g., PCT publications WO 93/17715, WO 92/08802, WO 91/00360, and WO 92/05793; Tutt, et al., J. Immunol. 147:60-69(1991); U.S. Pat. Nos. 4,474,893, 4,714,681, 4,925,648, 5,573,920, and 5,601,819; and Kostelny et al., J. Immunol. 148:1547-1553 (1992).

Examples of specific methods and protocols for the generation of recombinant antibody expression libraries can be found herein (see, e.g., Examples 1, 3-5) and in Huse et al., 1989, Science 246: 1275-1281; McCafferty et al., 1990, Nature 348:552-554; Rosok et al., 1996, J Biol Chem 271:22611-22618; Baca et al., 1997, J Biol Chem 272:10678-10684; Wu et al., 1998, Anal Biochem 256:169-177; Sheets et al., 1998, PNAS USA 95:6157-6162; de Haard et al., 1999, J Biol Chem 274:18218-18230; Knappik et al., 2000, J Mol Biol 296:57-86; Soderlind et al., 2000, Nature Biotechnol 18:852-856; and Azriel-Rosenfeld et al., 2004, J Mol Biol 335:177-192 among others.

It is also specifically contemplated that large populations of other compounds, such as natural or synthetic compound libraries may also be screened using the screening process of the present invention so long as they can be immobilized onto a solid support. Such large populations of other compounds can be immobilized onto a solid support and then screened for the identification of molecules that selectively bind to one or more ligands of choice. In one embodiment, such large populations of compounds can be selectively immobilized. A large population of binding molecules may be synthetic compounds produced by, for example, combinatorial chemistry methods known to one skilled in the art.

### 6.3 Immobilization

In order to identify a binding polypeptide having selective binding affinity for a desired ligand, it is necessary to immobilize the population of binding molecules to be screened and then to contact the binding molecules with the desired ligand. In a one embodiment, the population of binding molecules is immobilized. In another embodiment, the population of binding molecules is selectively immobilized

The term “selective” or “selectively” when referring to the immobilization of a binding molecule to a solid support as used herein refers to an interaction that can be discriminated from unwanted interactions. Discrimination can be based on, for example, affinity or avidity and can be derived from multiple low affinity interactions or a small number of high affinity interactions. As used herein, the terms “selective immobilization” and “selectively immobilized” are intended to encompass both specific interactions such as, for example, the interaction of the binding molecule with an antibody which is specific for an epitope present on the binding molecule and those interactions which derive from an inherent property of the binding molecule such as, for example, the interaction of a hydrophobic domain with a plastic surface as well as those interactions mediated by a chemical moiety such as crossing-linking agents.

Without wishing to be bound by any particular theory or mechanism, it is contemplated that the selective immobilization of the population of binding molecules functions to increase the sensitivity of the binding interaction being measured (e.g., binding molecule-ligand interaction). The selective immobilization of the population of binding molecules to a solid support serves to separate the binding molecule population from irrelevant and/or contaminating molecules, which can be present in the reaction. Thus, immobilizing the binding molecule population results in significant enrichment of the binding molecule population which in turn reduces non-specific binding interactions with irrelevant and/or contaminating molecules that are not part of the population of binding molecules to be screened.

It will be understood by one skilled in the art that the difficulty of measuring binding interactions increases with the complexity of the binding assay as well as the number and diversity of the different species within the binding reaction. The screening process disclosed herein reduce these difficulties since the selective immobilization of the population of binding molecules substantially reduces the number of unwanted and/or irrelevant binding interactions by removing irrelevant and/or contaminating molecules from the reaction. Thus, the screening process of the invention provide improved sensitivity and specificity of detection through the selective immobilization of the population of binding molecules on a solid support.

Selective immobilization of the binding molecules may be utilized for the screening of binding molecules from either substantially purified or enriched populations of binding molecules such as those separated by an affinity technique, as well as from heterogeneous populations (e.g. cell extracts, conditioned media).

In a specific embodiment, the population of expressed soluble binding molecules is selectively immobilized. In particular the population of expressed soluble binding molecules is selectively immobilized on a solid support through the specific interaction with an agent bound and/or coupled to the solid support. Such agents include but are not limited to, antibodies, polypeptides, aptamers, tethers, linkers, and chemical moieties that allow covalent or non-covalent interactions sufficient to hold the population of binding molecules to the solid support. It is also contemplated that the inherent properties of the binding molecule may facilitate selective immobilization. For example a hydrophobic domain of a binding molecule will allow selective immobilization to a plastic support.

In a specific embodiment, an antibody, which recognizes an epitope present on the population of binding molecules, is bound and/or coupled to the solid support. For example, and antibody that recognizes a constant domain, could be used to immobilize a population of antibody binding molecules. Alternatively, an antibody that recognizes a specific epitope tag (e.g., HA, FLAG, Myc, 6xHis epitope tags, supra) can be used to immobilize a population of binding molecules engineered to include said epitope tag. Similarly, biotin or avidin can be used to immobilize a population of binding molecules engineered to contain the other partner of the binding pair (supra). For example, biotin can be coupled/bound to solid support and the binding molecules can be engineered to contain avidin. Alternatively, avidin can be coupled/bound to solid support while the population of binding molecules can be labeled with biotin.

In another specific embodiment, an aptamer, which recognizes an epitope and/or domain present on the population of binding molecules, is bound and/or coupled to the solid support. Methods for the selection of an aptamer specific for a particular target are well known in the art (see Jayasena, S. D., 1999, Clin. Chem. 45:1628-1650, for review of aptamer technology).

The use of solid supports allows for the immobilization of high concentrations of binding molecules. High concentrations of immobilized binding molecules facilitates the rapid screening of very large numbers of molecules and further, can serve to increase the ability to detect lower affinity interactions with ligands and to detect ligands in low concentrations.

Essentially any solid support is amenable for use in the screening process of the invention. One skilled in the art will know what support is necessary to fit a particular need and has the capacity to immobilization all, or a statistically representative number of a population of binding molecules. Solid supports can be made porous materials that allow greater densities of immobilized binding molecules to be achieved. Additionally, solid supports can be chosen with characteristics compatible with the manipulations (e.g., washes, incubations, visualization methods) required for the screening process while maintaining the ability to retain the binding molecule population. Such manipulations can be important for removing unbound ligand populations and for washing to remove non-specific interactions as well as for visualization of ligand-binding molecule interactions. Ease of manipulation is an advantage when performing ultra high throughput screening, as multiple manipulations are often required. Solid supports of the invention include but are not limited to membranes such as nitrocellulose, nylon, polyvinylidene difluoride, plastic, glass, polyacrylamide and agarose. Solid supports can be made in essentially any size or shape so long as they support the immobilization of the population of binding molecules (e.g., beads).

It is specifically contemplated that solid supports used in the screening process of the invention may be modified. For example, a wide variety of functional groups can be bound and/or coupled to the surface of the solid support to facilitate the immobilization of the population of binding molecules or enhance other aspects of the screening process (e.g., detection, washing). Functional groups that can be bound to the solid support include but not limited to, chemical moieties (e.g., cross-linkers), aptamers (e.g., RNA, DNA), polypeptides (e.g., antibodies, streptavidin) and other biomolecules (e.g., biotin, lipids). The functional groups may mediate the immobilization of the population of binding molecules by a number of interactions including but not limited to, covalent, non-covalent, hydrolyzable, photo-labile, photo-activated, reversible and non-reversible.

To allow the rapid screening of very large populations of binding molecules the present invention makes use of high density plating methods that allow for the screening of at least 3,800 independent clones per mm² of solid support. Previous methods typically allow for the screening of only about 1 to 6 independent clones per mm² of solid support. For example, a diverse library of antibody molecules can easily exceed 10⁹ independent clones. Using conventional methods a library of this size would require, for example, at least 20,000 filters (83 mm in diameter) to screen the entire population. Using the screening process of the present invention the entire library can be screened using only 33 filters. Thus, the present invention provides an improvement of at least 600 fold over previous methods.

In one embodiment, the expression library clones are plated at high density. In a specific embodiment, the expression library clones are plated at a density of greater then about 10, or greater then about 100, or greater then about 1,000, or greater then about 2,000, or greater then about 3,000, or greater then about 4,000, or greater then about 5,000, or greater then about 6,000, or greater then about 7,000, or greater then about 8,000, or greater then about 9,000, or greater then about 10,000, or greater then about 25,000, or greater then about 50,000, or greater then about 75,000, or greater then about 100,000 clones per mm². In another specific embodiment, the expression library clones are plated at a density of greater then 10, or greater then 100, or greater then 1,000, or greater then 2,000, or greater then 3,000, or greater then 4,000, or greater then 5,000, or greater then 6,000, or greater then 7,000, or greater then 8,000, or greater then 9,000, or greater then 10,000, or greater then 25,000, or greater then 50,000, or greater then 75,000, or greater then 100,000 clones per mm². In still another specific embodiment, the expression library clones are plated at a density of between about 1,000 and about 10,000 clones per mm². In yet another specific embodiment, the expression library clones are plated at a density of between 1,000 and 10,000 clones per mm². The clones may be individual cells (e.g., yeast or bacteria) expressing a soluble population of binding molecules or may be bacterial cells infected with a phage encoding a soluble population of binding molecules. In a particular embodiment, clones are cells infected with a lytic phage encoding a soluble population of binding molecules. It is specifically contemplated that the soluble binding molecules may be secreted from a cell or may be released from a cell after lysis. Lysis may be promoted by numerous methods know to one skilled in the art including but not limited to chemical methods (e.g., alkaline lysis) and biological methods (e.g., infection with a lytic phage). It is also contemplated that the clones of soluble binding molecules may represent pools of individual molecules derived from any source (e.g., random peptide library and combinatorial chemical library) and immobilized to a solid support at the densities described above.

### 6.4 Ligands and Detection

As used herein the term “ligand” includes any molecule that is capable of being recognized by a binding molecule that has a binding affinity for the ligand. A ligand may be a protein, a DNA, a lipid, a carbohydrate or a small molecule. In one embodiment, the soluble ligand can be any molecule that can be selectively bound by a binding molecule including but not limited to, peptides, polypeptides, nucleic acid, carbohydrate, lipid, or organic compound. It will be understood by one skilled in the art that molecules discussed above as binding molecules can also be ligands. For example, a cell surface receptor (e.g., integrins, growth factor receptors or cytokine receptors) can be used as ligands to screen a population of binding molecules (e.g., random peptide, antibody or combinatorial chemical library) to identify binding molecules that could be used as agonists or antagonists for these receptors.

In one embodiment, the ligand comprises at least one domain or peptide derived from a cell surface protein (e.g., glycosylated surface proteins), cancer-associated proteins, cytokines, chemokines, peptide hormones, neurotransmitters, cell surface receptors (e.g., cell surface receptor kinases, seven transmembrane receptors, virus receptors and co-receptors), extracellular matrix binding proteins, cell-binding proteins, antigens of pathogens (e. g., bacterial antigens, malarial antigens, and so forth). In another embodiment, the ligand comprises at least one domain or peptide derived from a tyrosine kinase or a tyrosine kinase ligand. Contemplated tyrosine kinases and tyrosine kinase ligands include but are not limited to, receptor tyrosine kinases (e.g., EGFR/epidermal growth factor, Eph/Ephrin, FGF/fibroblast growth factor, FN/fibronectin insulin, IGF/insulin like growth factor, NGF/nerve growth factor, PDGF/platelet-derived growth factor, and Tie/angiopoietin receptor families) and non-receptor tyrosine kinases (e.g., Src, Tec, JAK, Fes, Abl, FAK, Csk, and Syk families).

In one embodiment, the screening process of the invention is used to screen for binding molecules exhibiting selective affinity for a single ligand. In addition, it is specifically contemplated that the screening process of the invention can be used to screen a population of binding molecules for binding to a plurality of ligands.

A ligand and/or ligand population will be selected depending on the need and intended use of the binding molecule as well as the characteristics of the ligands or ligand compositions. For example, using the screening process of the invention, binding molecules can be identified exhibiting selective affinity for a single ligand or for ligand populations as complex as entire cells or tissues as well as simple ligand populations of just a few species.

A ligand or ligand population can be substantially purified or contain various amounts of other irrelevant species. For example, a single ligand can be a well characterized highly purified molecule (e.g., a recombinant protein) while a population of molecules can be derived from a number of sources including, for example, partially or substantially purified preparations of one or more ligand, or crude preparations of cell lysates or homogenates. Additionally, the invention also provides a screening process of identifying a binding molecule having selective affinity for a single ligand, or population of ligands, wherein the ligands are polypeptides or other macromolecules in a cell lysate. It is specifically contemplated that ligands which are not biochemically well characterized (e.g., cell lysate) can be used in the methods of the invention. Additionally, the screening process of the invention can be used for the identification of binding molecules that are selective for one or a few members of a population. For example, if it is desired to produce a binding molecule selective for any member of a population of ligands, then each individual member can be combined into a single population and screened simultaneously using the screening process of the invention. A single population of ligands can be generated by numerous methods including but not limited to, pooling together a number of different ligand preparations, by expressing a number of different molecules together in a single cell.

The ligand population used in the screening process can be composed of different sizes of either substantially purified molecules or crude cell-preparations or other complex compositions. Generally, a single ligand or a simple population of two different ligand species is used. However, a simple ligand population can be composed of 3, 4, 5, 6, 7, 8, 9, 10 or more different ligands can be used. It is also specifically contemplated that the screening process of the present invention can be used for moderate ligand populations containing between about ten and several hundreds of different ligand species and complex ligand populations containing about tens of thousands of different ligand species, for example, the number of different molecules within a cell. The choice of the population size and type will depend on the need and intended use of the binding molecule. One skilled in the art will know which size and type of population is suitable for a particular need. In all cases, the ligand and/or ligand population can be substantially purified or contain various amounts of other irrelevant species.

In one embodiment, the ligand and/or ligand population is soluble. Some ligands are inherently soluble while others may require additional manipulations including but not limited to the introduction of additional components to solubilize them (e.g., detergents, chaotropic agent). It is specifically contemplated that the use of a soluble ligand will facilitate the efficient screening of an immobilized population of binding molecules by preventing the formation of insoluble ligand aggregates that may not be capable of interacting with any binding molecule. In the case where a binding molecule is desired that interacts with ligands in their native state it is contemplated that the ligands of interest are inherently soluble as the manipulations required to solubilize the ligand can result in conformational alterations leading to the identification of binding molecules that do not recognize the native state of the ligand.

The invention provides a screening process for the ultra high throughput screening of a population of binding molecules to identify at least one binding molecule exhibiting selective affinity for at least one ligand. The binding molecule is identified by contacting a population of binding molecules with at least one ligand. The ligands themselves are then detected by an appropriate detection method.

In one embodiment, the ligand selectively bound to the immobilized binding molecules is detected. It is specifically contemplated that the bound ligand may be detected by direct or indirect methods and can involve detection of, for example, light emission, radioisotopes, color development, or any method that allows the ligand to be detected. Direct detection of a ligand can be performed by numerous techniques familiar to one skilled in the art including but not limited to, covalent modification of the ligand with a readily detectible moiety, for example, chemical modification using radioisotopes such as iodination. Direct methods can also involve the fusion of an appropriate detection molecule to the ligand, for example, the ligand can be fused to luciferase and detected by light emission or can be fused to and enzyme (e.g., lac Z, Horseradish peroxidase, alkaline phosphatase and infra) and detected by appropriate colorimetric detection.

Indirect detection of a ligand can be performed by methods well known in the art including but not limited to, using a second molecule known to interact with the ligand. The second molecule is either itself detected direct or indirect methods. For example, a ligand can be biotinylated and detected with an appropriately labeled avidin molecule. Hapten molecules can be utilized in a similar manner (supra). Additionally, an antibody specific for a ligand can be detected using a secondary antibody capable of interacting with the first antibody specific for the ligand, again using the detection methods described above for direct detection.

Both direct and indirect detection can be facilitated by coupling the ligand or the second molecule used for indirect detection to a detectable substance. Examples of detectable substances include various enzymes, prosthetic groups, fluorescent materials, luminescent materials, bioluminescent materials, radioactive materials, positron emitting metals, and non-radioactive paramagnetic metal ions. For example, the detectable substance may be coupled or conjugated either directly to an antibody (or fragment thereof) that recognizes the ligand, or indirectly, through an intermediate (such as, for example, a linker known in the art) using techniques known in the art. See, for example, U.S. Pat. No. 4,741,900 for metal ions that can be conjugated to antibodies for use as diagnostics according to the present invention. Examples of suitable enzymes include horseradish peroxidase, alkaline phosphatase, beta-galactosidase, or acetylcholinesterase; examples of suitable prosthetic group complexes include streptavidin/biotin and avidin/biotin; examples of suitable fluorescent materials include umbelliferone, fluorescein, fluorescein isothiocyanate, rhodamine, dichlorotriazinylamine fluorescein, dansyl chloride or phycoerythrin; an example of a luminescent material includes luminol; examples of bioluminescent materials include luciferase, luciferin, and aequorin; and examples of suitable radioactive material include ¹²⁵I, ¹³¹I, ¹¹¹In or ⁹⁹Tc.

In another embodiment, a ligand additionally comprises a detection domain. A detection domain is any molecule that facilitates the detection of a ligand. In one embodiment, a detection domain will allow for an amplification of the detection signal resulting in a greater sensitivity of detection. For example, the detection domain may serve to enlarge the number of second molecules (e.g., biotin molecules or antibodies) that interact with a ligand which can then themselves be detected resulting in an amplification of the detection signal.

In a specific embodiment, polypeptide ligands are recombinantly engineered to include one or more domains for which there are detection methods. For example, vectors include, but are not limited to, the E. coli expression vector pUR278 (Ruther et al., 1983, EMBO 12:1791), in which the ligand coding sequence may be ligated individually into the vector in frame with the lac Z coding region so that a lac Z-fusion protein is produced; pIN vectors (Inouye & Inouye, 1985, Nucleic Acids Res. 13:3101-3109; Van Heeke & Schuster, 1989, J. Biol. Chem. 24:5503-5509); and the like. The lac Z protein can either be detected directly using colorimetric detection methods or indirectly using one or more antibodies that specifically recognize the lac Z. Additionally, antibodies specific for lac Z may be combined with those that recognize the ligand resulting in an amplification of the detection signal.

In the case of an insoluble polypeptide ligand pGEX vectors may also be used to express the ligand polypeptide as a fusion proteins with glutathione 5-transferase (GST). In general, ligand-GST fusion proteins will be soluble even when the ligand alone is not. Additionally, the ligand-GST fusion protein can easily be purified from lysed cells by adsorption and binding to matrix glutathione agarose beads followed by elution in the presence of free glutathione. The GST domain also functions as a detection domain. The generation of ligand-GST, ligand-lac Z and other similar ligand-detection domain fusions are particularly advantageous for small peptide ligands which would be difficult to detect without the addition of a larger more readily detected molecule.

In another embodiment, a ligand additionally comprises a detection domain that allows the ligand to form multimers. For example the ligand can be fused to an antibody Fc domain that will promote dimerization. Methods for fusing or conjugating polypeptides to the constant regions of antibodies are known in the art. See, e.g., U.S. Pat. Nos. 5,336,603, 5,622,929, 5,359,046, 5,349,053, 5,447,851, 5,723,125, 5,783,181, 5,908,626, 5,844,095, and 5,112,946; EP 307,434; EP 367,166; EP 394,827; International Publication Nos. WO 91/06570, WO 96/04388, WO 96/22024, WO 97/34631, and WO 99/04813; Ashkenazi et al., 1991, Proc. Natl. Acad. Sci. USA 88: 10535-10539; Traunecker et al., 1988, Nature, 331:84-86; Zheng et al., 1995, J. Immunol. 154:5590-5600; and Vil et al., 1992, Proc. Natl. Acad. Sci. USA 89:11337-11341. Alternatively, the ligand can be fused to leucine zipper domains. Examples of leucine zipper domains suitable for producing soluble oligomeric proteins are described in PCT application WO 94/10308, and the leucine zipper derived from lung surfactant protein D (SPD) described in Hoppe et al. (FEBS Letters 344:191, 1994). The use of a modified leucine zipper that allows for stable trimerization of a heterologous protein fused thereto is described in Fanslow et al. (Semin. Immunol. 6:267-278, 1994). Recombinant fusion proteins comprising a soluble polypeptide fused to a leucine zipper peptide are expressed in suitable host cells, and the soluble oligomer that forms is recovered from the culture supernatant. Certain leucine zipper moieties preferentially form trimers. One example is a leucine zipper derived from lung surfactant protein D (SPD), as described in Hoppe et al. (FEBS Letters 344:191, 1994) and in U.S. Pat. No. 5,716,805.

In one embodiment, the clone(s) expressing the binding molecule(s) that recognize and bind to the ligand is/(are) isolated. It is specifically contemplated that the solid support can provide a template for the isolation of a subset of clones that contains the clone(s) expressing the binding molecule(s) that recognize and bind to the ligand. This smaller population can then be screen using a modification of the screening process of the invention. Said modification comprising plating the subset of clones at a lower density. In a specific embodiment, the subset of clones is plated at a density low enough to allow a single clone to be isolated but high enough for each clone present in the subset to be represented on the solid support at least once. It is also contemplated that the subset of clones that contains the clone(s) expressing the binding molecule(s) that recognize and bind to the ligand may be screened by alternative methods known to one skilled in the art. Alternative methods include but are not limited to, ELISA assay and FACS analysis.

### 6.5 Selectable Markers and Selection

The library production method of the present invention comprises the first step of generating a library of clones comprising polynucleotides encoding molecules ligated to a polynucleotide encoding a selectable marker. Selectable markers are generally described below and certain specific examples are detailed in Example 3, supra. It is specifically contemplated that the polynucleotide encoding a selectable marker may be the same as that required for selection and/or maintenance of a transformed host cell comprising a library clone, or a second polynucleotide encoding a second selectable marker may be utilized.

Selectable markers encompass a diverse group of genes encoding a desired trait which may be readily selected and/or screened for. Selectable markers may be divided into three general categories; 1) Drug resistant marker genes which confer the trait of resistance to a specific drug. For example, the β-lactamase gene confers resistance to ampicillin and carbanicillin, neomycin phosphotransferse type II (NPT II) confers resistance to neomycin/kanamycin/G418 (Colberre-Garapin et al., 1981, J. Mol. Biol. 150:1), chloramphenicol acetyltransferase confers resistance to chloramphenicol (Herrera-Estrella at al., 1983, Nature 303, 209-213), dihydrofolate reducatase (dhfr) confers resistance to methotrexate (Wigler et al., 1980, Natl. Acad. Sci. USA 77:3567; O'Hare et al., 1981, Proc. Natl. Acad. Sci. USA 78:1527), gpt confers resistance to mycophenolic acid (Mulligan & Berg, 1981, Proc. Natl. Acad. Sci. USA 78:2072) and hygromycin phosphotransferse (hygro) confers resistance to hygromycin (Santerre et al., 1984, Gene 30:147). 2) Metabolic or auxotrophic marker genes which enable transformed cells to synthesize an essential metabolite, usually an amino acid, which the cells cannot otherwise produce but require for growth allowing cells to grow in the absence of the metabolite. For example, HIS3, LEU2, TRP1 and URA3 confer the ability of certain auxotrophic yeast strains to grow in media lacking histidine, leucine, tryptophan and uracil respectively. 3) Screenable or purification markers genes which encode for a protein or protein domain that can be identified through various laboratory assessments or purification techniques or facilitates the purification/identification of clones expressing the protein domain. For example, beta-galactosidase (beta-gal) that is detected using X-gal (Helmer at al., 1984, Bio/Technology 2, 520-527), luciferase (lux) that is detected using hydrocarbon compounds (Koncz at al., 1987, PNAS 84, 131-135 )), or a protein domain such as a calmodulin binding domain that is purified by using calmodulin affinity purification.

It will be understood by one of skill in the art that those clones which do not express a functional molecule (e.g., a molecule having a premature stop codon or a frameshift mutation) will likely generate either no fusion protein or a nonfunctional fusion protein. Clones expressing such nonfunctional molecules may be selected against by growing the library of clones under selection conditions whereby those clones which do not express a functional fusion protein are eliminated. Accordingly, the library production method of the present invention further comprises the second step of growing the library of clones under conditions which select for clones expressing functional molecules.

It will be apparent to one of skill in the art which selectable marker and selection conditions to use in the library production method of the present invention. The choice of selectable marker and selection conditions will depend on the choice of library to be generated as well as the expression vector and host cell utilized.

### 7. EXAMPLES

The invention is now described with reference to the following examples. These examples are provided for the purpose of illustration only and the invention should in no way be construed as being limited to these examples but rather should be construed to encompass any and all variations which become evident as a result of the teachings provided herein.

### 7.1 Example 1

Ultra High Throughput Screening of a Human scFv Library

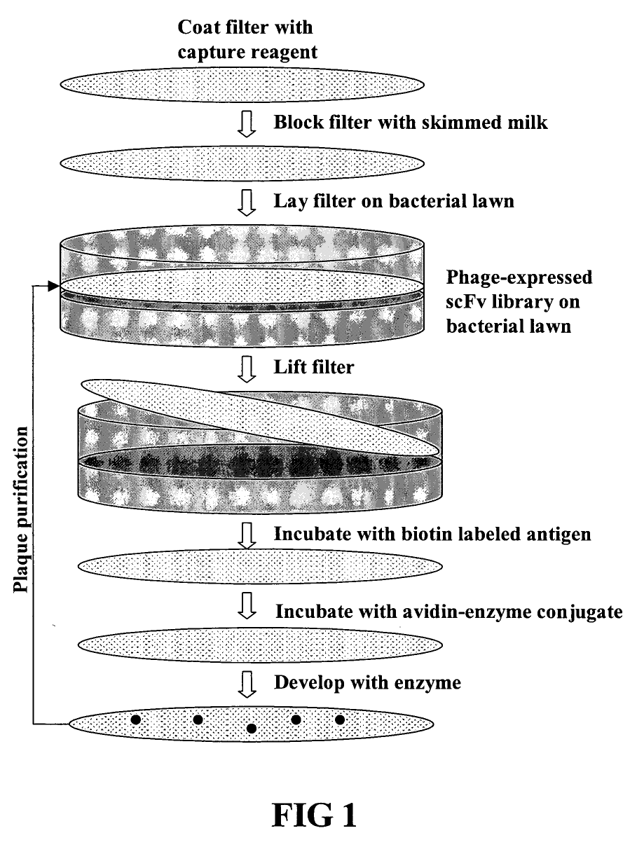

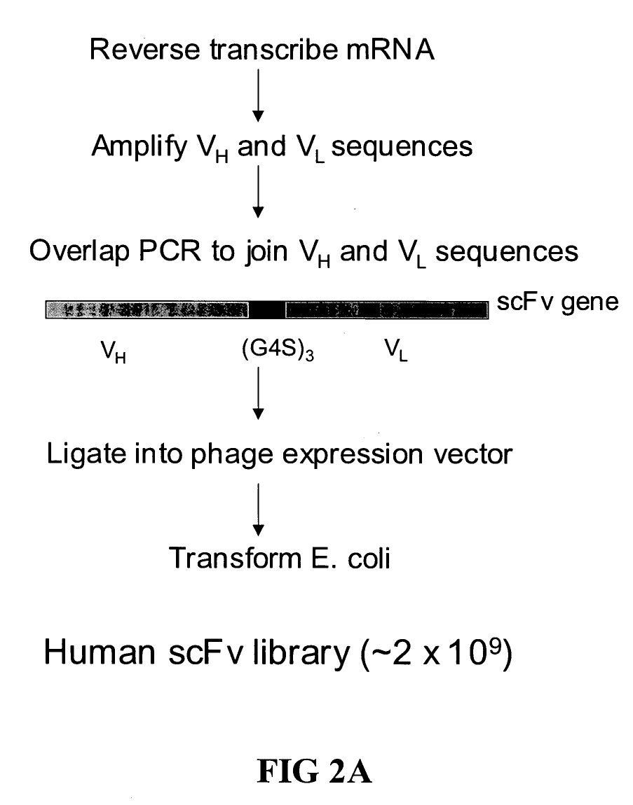

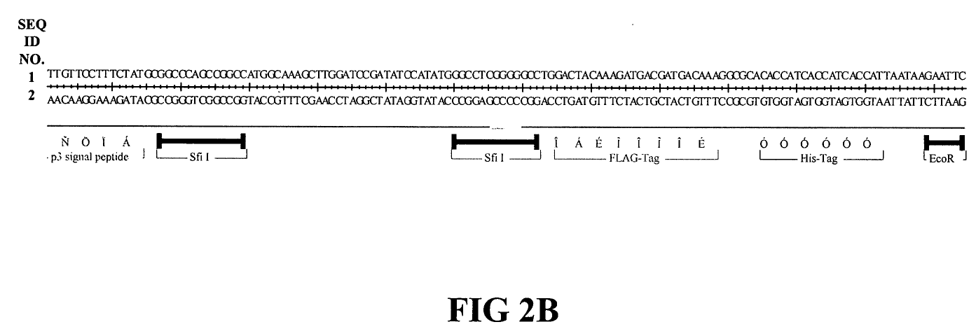

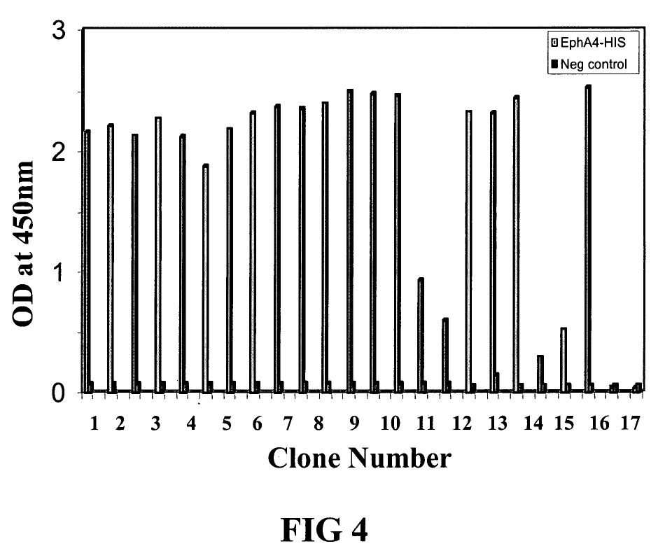

A large phage scFv expression library containing ˜2×10⁹ members was generated from human lymph node and spleen tissues (See, FIG. 2). The entire library was screened using a biotinylated EphA4-Fc fusion protein (See, FIGS. 1, 3 and 4). After three rounds of screening a panel of 24 clones was isolated 20 of which showed strong binding in ELISA assays (See, FIG. 4).

7.1.1 Materials and Methods

Production of Naïve Human scFv Library: Generation of the Human scFv library was essentially as described in Gao et al., 1999, J. Am. Chem. Soc. 121:6517-6518; and Mao et al., 1999, Proc Natl Acad Sci USA 96:6953-8 with the following changes, a cloning site, complete with epitope tags (see, FIG. 2B) that can serve as immobilization domains, was engineered into M13 and used as an expression vector. Additionally, the scFvs used here are in their native form (i.e., not fused to an M13 coat protein). Briefly, a human mRNA from lymph nodes and spleen tissues was reverse transcribed and the V_{H} and V_{L} sequences were amplified by PCR. Overlap PCR was utilized to join the V_{H} and V_{L} sequences forming a polynucleotide encoding a scFv gene. The scFv genes were then ligated into the M13 phage expression vector and transformed into E. coli. See FIG. 2A for schematic. The complexity of the library is ˜2×10⁹.

Biotin Labeling of Ligand: Commercially prepared EphA4-Fc (R&D system, Cat# 369-EA-200) was dialyzed against PBS (pH 7.2). The final concentration of EphA4-Fc after dialysis was 0.83 mg/ml. 1 ml of EphA4-Fc was used for biotinylation. Immediately before use, a 10 mM solution of Sulfo-NHS-LC-Biotin (PIERCE. Cat#: 21335) was prepared in water. 16.6 μl of 10 mM biotin reagent solution was added to 1 ml of dialyzed EphA4-Fc (molar fold excess of biotin is 20) and the reaction mixture was incubated on ice for two hours. Nonreacted biotin was removed from the biotinylated EphA4-Fc by dialyzing against PBS (pH 7.2).

Ultra High Throughput Screening: Day 1—In the afternoon, a single colony of TG1 from M9 plate was used to inoculate 2XYT. The culture was incubated at 30° C. overnight.

Day 2—Inoculate TG1: The overnight culture of TG1-Blue was diluted 1:100 in 2XYT and incubated at 37° C., 250 rpm for about 1.5-2 hours (OD_{600 nm}=0.5˜0.8). Infect the TG1 with phage: The phage was diluted into PBS at a concentration of about 10¹⁰ pfu/ml for capture lift assay and about 10⁵ pfu/ml for phage titering. Top agar solution (SB+0.7% agar) was aliquoted into 12 ml tubes (6 ml/tube) and kept in 50° C. water bath until use. The following mixture was prepared:

a. TG1 from step 1: 800 μl

b. IPTG (1M): 6 μl

c. Diluted phage solution: 6 μl

400 μl of above mixture was added to 6 ml of top agar, mixed and then gently poured onto the top of a 100 mm plain LB agar plate and allowed to set up at room temperature for 10 min. The plated were then incubated at 37° C. for about 5-6 hours. Prepare the filters: During the incubation of the plates, one side of 83 mm NC membranes was labeled with pencil. Anti-Flag antibody (M2 Ab, 4.9 mg/ml from Sigma) was diluted 1:500 with PBS (pH 7.2) and placed into a 100 mm Petri dish. The labeled membranes were placed on the surface of the antibody solution with the labeled side up and incubated for 3 hours at room temperature on platform shaker with slow speed. The filters were then turned over and incubated for another 30 min. The antibody solution was removed and the filters were blocked with 4% skimmed milk (from Bio-Rad) in PBS for 2 hours at RT. The filters were then rinsed three times with PBS and dried in a chemical hood. Incubation of filter on the bacterial/phage lawn: The bacteria/phage plates were removed from incubator. Isolated plaques were visible on the titering plate (here is 10⁸ dilution plate). The dried filter was gently laid on the surface of bacterial/phage lawn with labeled side up and the filter position was marked by poking holes in the filter with a needle. The plates were then incubated at RT (25° C.) overnight (in a moisture container).

Day 3—The filters were carefully peeled off the plates and rinsed with PBS 2 times and then washed 6 times with TPBS (PBS+0.1% Tween 20) using a vacuum washer (labeled side up for three times and labeled side down for another 3 times). The membranes were then incubated with EphA4-FC-biotin diluted 1:1000 in 1% BSA in SuperBlocking Buffer (PIERCE) with the labeled side down (4 ml/filter). The stock concentration of EphA4-FC-biotin was 0.8 mg/ml. The membranes were then incubated for 3 hours at RT with shaking on a rocking platform. The membranes were then washed 6 times with TPBS using vacuum washer (labeled side up for three times and labeled side down for another 3 times). The washed filters were then incubated in Avidin-AP solution diluted 1:4000 in 1% BSA in SuperBlocking Buffer (PIERCE, 10 ml/filter) for 1 hour with shaking. After this last incubation the filters were then washed as above and rinsed 3-5 times with PBS. The washing buffer was removed and NBT/BCIT solution (PIERCE, 5 ml/filter) was added to the plate containing the filters. The color was allowed to develop (3-5 min.) and the developed filter was dried and aligned with plate and positive plaques were picked for second round screening.

Antibody Screening/Elisa (2.5 ml scale): Day 1—In the afternoon, a single colony of TG1 from M9 plate was used to inoculate 2XYT. The culture was incubated at 30° C. overnight.

Day 2 Antibody Expression—Inoculate TG1. The overnight culture of TG1-Blue was diluted 1:100 in 2XYT and incubated at 37° C., 250 rpm for about 1.5-2 hours (OD₆₀₀ nm=0.5˜0.8) and then aliquoted into 12 ml tubes (2.5 ml/tube). High titer phage preparation: A well-isolated plaque was picked and used to inoculate the 2.5 ml culture from above. The tubes are incubated overnight at 37° C., shaking at 250-300 rpm. Coat antigen: The antigen (here is EphA4-His fusion protein and Synagis as negative control) is diluted to about 5-10 μg/ml in coating buffer (carbonate buffer, pH 9.6), added to a microtiter plate at 25 μl/well and incubated at 4° C. over night.

Day 3 ELISA-Blocking: The excess coating solution was removed and the wells were blocked with 4% skimmed milk in PBS (blocking buffer) at 50 μl/well for 1 hr at 37° C. During the incubation, the over night cell cultures were collected by centrifugation at 3500 rpm×20 min. The excess blocking solution was removed and 25 μl/well of over night supernatant was added. Incubate at 37° C. for 1 hour. The plates were washed with a plate washer and 25 μl/well of anti-Flag M2 antibody (1:1000 dilution in blocking buffer) was added to each well. The plate was then incubated for 30 min at 37° C. The plate was again washed with a plate washer and 25 μl/well of Goat anti-mouse (IgG-H+L)-HRP conjugate (1:1000 dilution in blocking buffer) was added to each well. The plate was incubated for 30 min at 37° C. The plate was washed with a plate washer, followed by washing one time with pipette (pipette up and down for 20 times), and 10 additional times with distil water. Develop: 25-35 μl/well of TMB substrate was added to each well and the color was allowed to develop for about 5 min. The reaction was stopped by adding an equal volume of 0.18 M H₂SO₄ and the absorbance was read at 450 nm.

Antibody Purification (800 ml scale): Day 1—In the afternoon, a single colony of TG1 from M9 plate was used to inoculate 10 ml of 2XYT. The culture was incubated at 30° C. overnight.

Day 2—2 ml of over night cell culture was diluted into 200 ml of 2XYT medium and grown in a shaker at 37° C., 250 rpm to OD 600 nm˜0.8. 250 μl of over night high titer phage (typically˜10¹² pfu/ml) was used to infect the 200 ml cells for 15 min at room temperature. 600 ml of 2XYT medium was added to the 200 ml of infected cells. The infected cells are grown at 37° C. for one hour and then at 30° C. over night.

Day 3—The cells were removed by centrifugation at 8000 rpm (Beckman JA-10 rotor) for 20 min and the supernatant was filtered by passing it over 0.45 μm filters. The filtered supernatant was loaded onto an anti-FLAG M2 agarose affinity column, which was pre-washed with PBS. The column was then washed with at least 10 column volumes of PBS. The antibody (scFv) was then eluted from the column with elution buffer (100 mM glycine, adjust the pH to 3). 1 M Tris-HCl (pH 8.0) was added to the eluted antibody to neutralize. The neutralized antibody was then dialyzed against PBS and concentrated to about 1 ml.

7.1.2 Discussion

Capture lift screening methods are commonly used to avoid some of the biases inherent in high throughput screening methods. However, they are of limited value for large diverse libraries thus their use has been limited to the screening of small library populations. Capture lift screens have been used successfully for the selection of antibody clones with increased affinity, for selection of humanized antibodies and more recently, for the discovery of novel antibody molecules from small libraries (diversity ˜10⁵). Here we describe for the first time a significant improvement to the capture lift methodology that allows for the rapid and efficient screening of very large libraries of binding molecules allowing the identification of rare clones from very large populations.

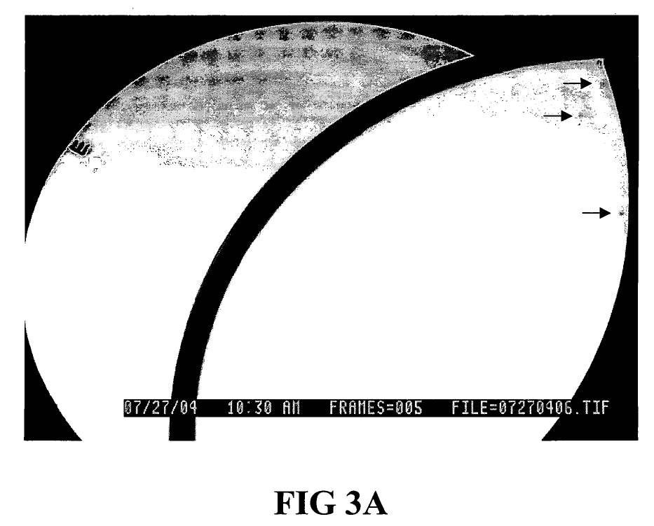

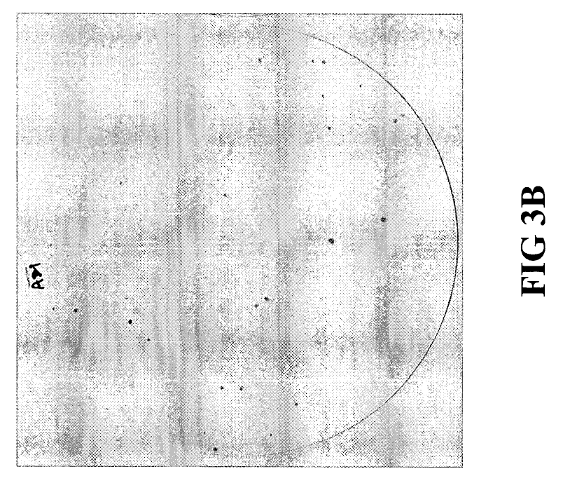

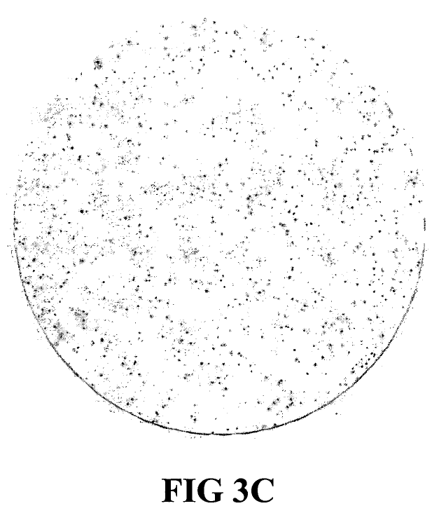

A large phage scFv expression library containing ˜2×10⁹ members was generated from human lymph node and spleen tissues. The library was plated at ultra high density with approximately 3800 clones per mm². FIG. 3 shows representative filters containing positive clones from the first round (3A), second round (3B) and third and final round (3C) of screening. The library was then screened using a biotinylated EphA4-Fc fusion protein. The use of the EphA4-Fc fusion allows a larger number of biotin molecules to be attached to each ligand resulting in a significant amplification of the signal upon detection with avidin-AP. The use of chemiluminescent based detection (see for example Salerno et al., 2003, J Chromatogr B Analyt Technol Biomed Life Sci 793: 75; Mattson, et al., 1996, Anal Biochem 240: 306; Kricka, 1991, Clin Chem 37: 1472) methods will allow significant amplification of the detection signal with or without the use of a ligand fused to secondary molecule for detection and should allow for an even greater number of clones to be plated on each plate.

Using the methodology presented at least 30 million clones can be screened on a single 82 mm nitrocellulose membrane. This is 300 times more clones per filter then any previously described capture lift method. Traditional capture lift methods would require between 20,000 and 40,000 plates (100 mm) for a library this size to be fully screened by. Utilizing the ultra high density plating and screening methods described here only ˜67 plates are required to screen the entire library.

### 7.2 Example 2

Isolation of an Anti-Idiotype scFv by Ultra High Throughput Screening

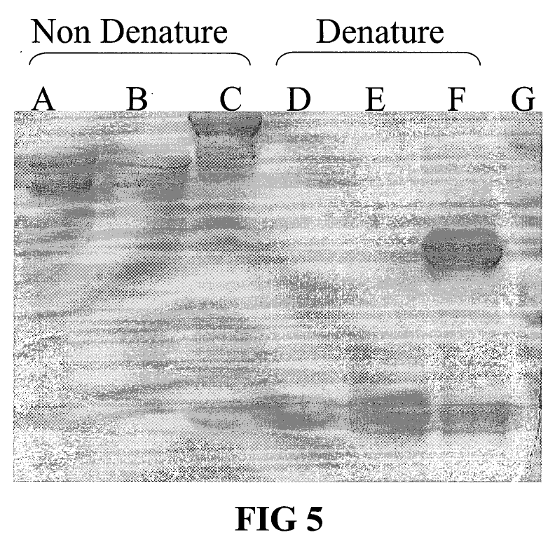

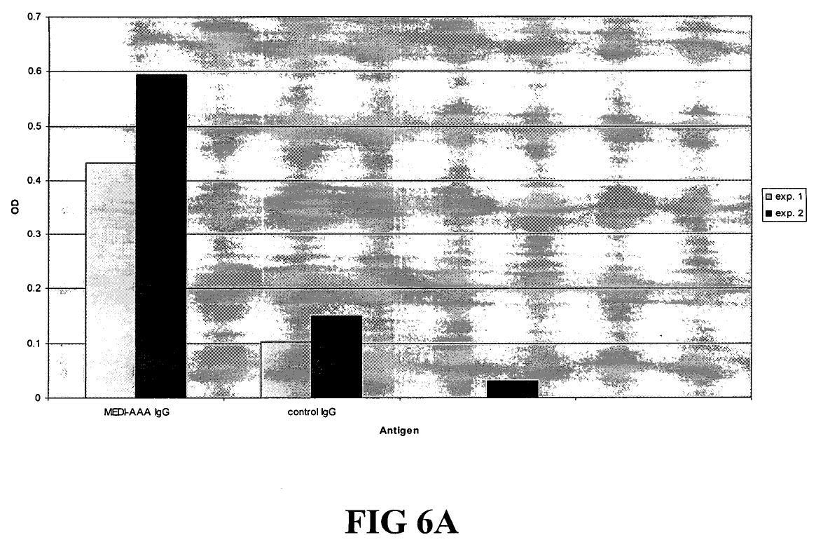

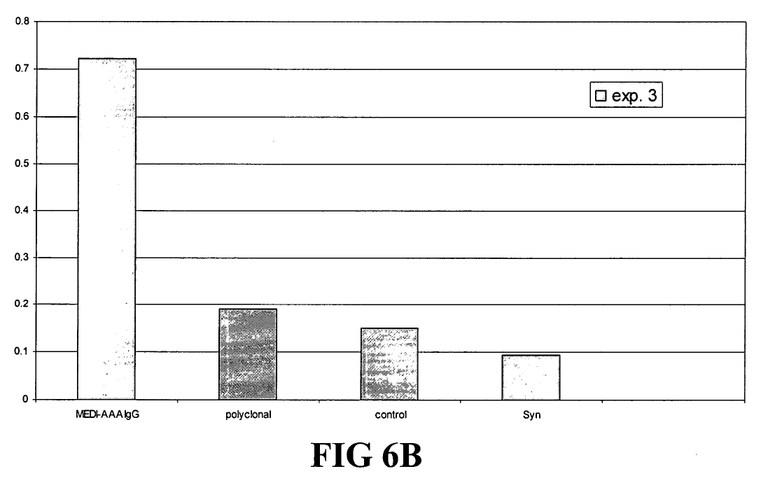

The library generated in Example 1 was also utilized for the identification and isolation of an anti-idiotype antibody which specifically recognizes the antigen binding domain of MEDI-AAA, an anti-interferon-alpha antibody. The library was screened using a biotinylated MEDI-AAA (Fab)2 fragment (FIG. 5). After two rounds of screening 4 clones were isolated, 1 of which showed strong binding in an ELISA assay to the MEDI-AAA antibody while not binding to several unrelated antibodies (see FIG. 6).

7.2.1 Materials and Methods

Preparation of MEDI-AAA (Fab)₂: The MEDI-AAA (Fab)₂ was prepared using the immobilized Pepsin reagent (Pierce cat. 20341). Following the manufacturer's directions, 500 μg of MEDI-AAA antibody was digested. The digested antibody was separated from the pepsin resin by centrifugation and the elutant was flowed over a protein A column to remove the antibody Fc fragment. The purified (Fab)₂ was concentrated using the Pierce concentration solution following the manufacturer's recommendations before it was dialyzed into 1× PBS pH 7.2 at 4° C. overnight. The final protein was analyzed on a 10% Bis-Tris protein gel (FIG. 5) using MOPS buffer (Invitrogen cat. NP0001).

MEDI-AAA (Fab)₂ Biotinylation: Two hundred micrograms of the MEDI-AAA (Fab)₂ was biotinyalted using the NHS-LC-biotin reagent following manufacturer's instructions (Pierce cat. 21338). A ratio of 20 biotins per (Fab)₂ molecule was used to ensure a high degree of sensitivity during the developing process. The unincorporated biotin was removed using a NAP5 desalting column (Pierce cat. 17-0853-01). The final labeled (Fab)₂ was analyzed as described above along with intact IgG and unlabeled (Fab)₂ under denaturing and non-denaturing conditions (FIG. 5).

Phage Cultures: A single colony of TG1 bacteria grown on a minimal media M9 (Teknova cat. M2100) plate was used to inoculate 1 ml of 2XYT (Teknova cat. Y0167) and incubated at 30° C. overnight. The overnight TG1 culture was used to start a 0.1 OD₆₀₀ culture in 2XYT at 37° C., 250 rpm until it reached mid log 0.5-0.8 OD₆₀₀. Top agar (super broth, 0.7% agar) was melted in a microwave and aliquoted into 15 ml falcon tubes, 6 ml per tube; the tubes were incubated in a 50° C. water bath until needed. The capture lift phage expression library (2.08×10⁹ pfu/μl) was diluted 1:40, 1:400 and 1:4×10⁶ to approximately to get 1×10⁷ pfu/μl, 1×10⁶ pfu/μl and 1×10² pfu/μl respectively. To infect TG-1 bacteria, 1 μl of the 1×10⁷ pfu/μl and 1 μl of 1×10⁶ pfu/μl diluted phage was added to 5 eppendorf tubes containing 800 μl of mid log TG-1 with 6 ul of 1M IPTG. Only one tube of TG1 was infected for the 1×10⁶ pfu/μl dilution (titer plate) and the remaining tube of TG-1 was used as a negative control. The infected TG-1 culture was combined with a tube of top agar and poured onto pre-warmed LB plates (100 mm). After allowing the top agar to solidify for 10 minutes at room temperature, the plates were incubated at 37° C. for 5 to 6 hours.

Filter Preparation: One side of ten nitrocellulose membranes (Protron Bioscience cat. 10401116, 82 mm) was labeled using a pencil denoting the antigen and membrane number. Anti-Flag M2 antibody (sigma cat.) was diluted 1:500 into 100 ml of 1× PBS pH 7.2 and 10 ml of this solution was added to each of 10 cm petri dishes. The nitrocellulose membranes were incubated in the anti-flag M2 antibody (Sigma Cat. F3165), labelled side up, for three hours on a low speed shaker at room temperature. After the initial incubation, the nitrocellulose membranes were inverted and incubated for an additional 30 minutes. The membranes were briefly rinsed and blocked with 10 ml of 4% skimmed milk (Bio-Rad cat. 170-6404) in 1× PBS pH 7.2 for two hours. After removing the milk solution the membranes were washed three times in 1× PBS pH 7.2 and allowed to dry in a hood.

Capture Lift Selection: The plates were removed from the incubator after plaques appeared on the titer plate, 1×10² dilution. A nitrocellulose membrane was carefully overlaid onto the surface of the top agar of the 1×10⁷ and 1×10⁶ plates to capture the scFv. A 21 gauge needle was used to make one hole at 12 o'clock, two holes at 4 o'clock and three holes at 8 o'clock position to mark the orientation and location of the filter on the plate. The plates were then incubated at 25° C. overnight. The 1:4×10⁶ library dilution plate was used to check the actual library titer. A Konte's 4L flask with side arm and filter holder (Fisher cat. K953840-4090) was used to wash the filters. First, the filters were carefully removed from the agar surface and both sides of the membranes were rinsed three times with PBST (1× PSB, 0.1% Tween 20) by connecting the holder to a vacuum while dispensing the TPBS from a wash bottle. To make hybridization solution, 0.1 μg/ml of biotinylated neutrostensin, 4 μg of the biotinylated MEDI-AAA (Fab)₂ and 100 μg of the GEA44 antibody were added to 1% BSA in superblock solution (Pierce cat. 37515). Each membrane was incubated in 4 ml of hybridization solution in a 10 cm petri dish with gentle agitation for 3 hours at room temperature. Using the filter holder and vacuum, both sides of the membranes were washed three times with PBST. The filters were incubated with 10 ml of 1:4000 Avidin-AP (Pierce Cat. 31002) in blocking buffer for 1 hour at RT with gentle shaking. Prior to developing the filters with 5 ml of NBT/BCIT (Pierce cat. 34042) solution, the filters were washed three times on both sides with PBST. After the brown positive dots appeared, the filters were rinsed with water to stop the reaction. The filters were dried in a hood and photocopied on transparency sheet. Using the holes made in the filter to mark the location and orientation, the plaque plate was placed on the transparency and the needle holes in the agar were aligned with those on the transparency sheet. The plaques above the positive spot were picked with a large orifice micropipette tip (VWR, Cat#:53503-614) and transferred to elution buffer (10 mM Tris, 100 mM Nacl, pH 7.4). Starting with the elution phage (˜2-5×10² pfu/μl), a 1:10 dilution (˜2-5×10⁴ pfu/μl) was used to prepare the plaques plates, as described before, for the second round of capture lift. One filter was used for each positive plaque picked.

Phage Production: The positive plaques eluted from the second round of capture lift were diluted to 1:200 (1-3×10² pfu/μl) and plated, as before, on a 10 cm petri dish. Individual plaques were picked into 96 a well plate with 250 μl of elution buffer. After allowing the plaques to elute out of the agar, 200 ul of the eluted phage was used to inoculate 500 μl of mid-log TG1 in a deep well plate. The culture was incubated overnight at 30° C. for phage production.

ELISA Screening: ELISA microtiter plates were coated overnight at 4° C. with 50 μl of MEDI-AAA at 5 μg/ml and control antibodies. Control antibodies included a commercial polyclonal human IgG (Jackson Immunoresearch Lab, Cat. 009-000-003), Synagis® and an unrelated antibody having a light chain framework that shares a high degree of homology (77 out of 81 framework residues are identical) with MEDI-AAA. The plates were blocked with ELISA blocking solution (2% milk in 1× PBST) for one hour at room temperature. Also, 48 μl of overnight phage supernatant was blocked with 12 μl of 5× ELISA blocking solution for one hour at room temperature. After the incubation, the plates were washed five times with 1×PBST using an E1ₓ405 plate washer and 50 μl of pre-blocked phage supernatant was added to each well. After an hour incubation at room temperature, the plates were washed again as before and 50 μl of a 1:2000 anti-flag M2 (Sigma) antibody dilution in blocking solution was added to each well. The plates were then incubated at room temperature for an hour at room temperature and washed five times using E1ₓ405 plate washer. To complete the ELISA sandwich, 50 μl of 1:4000 goat anti-mouse HRP antibody (Pierce cat. 31164) in blocking solution was added to each well and incubated at room temperature for an hour. The plates were washed ten times with PBST using a E1ₓ405 plate washer and 50 μl of TMB substrate (KPL cat. 52-00-03) added. After 5-10 minute incubation, the reaction was stopped by adding 50 μl of 0.2M of H₂SO₄. The Plates were read at 450 nm and the signal for each antibody was plotted (FIGS. 6A and B).

7.2.2 Results

The phage scFv expression library generated in Example 1 was screened by ultra high throughput (plated at a density of approximately 126-1267 clones per mm²) and screened using a biotinylated MEDI-AAA (Fab)₂ fragment (see FIG. 5) to identify anti-idiotype scFv clones. After two rounds of screening 4 clones were isolated (data not shown), 1 of which showed strong binding in an ELISA assay to the MEDI-AAA anti-interferon-alpha antibody while not binding to BSA or several unrelated antibodies (see FIG. 6). In particular the anti-idiotype scFv did not show significant binding to a human polyclonal antibody preparation (FIG. 6B) or an unrelated human antibody (control) having a highly related light chain (FIG. 6A and B). The use of the ultra high throughput screening method allowed the rapid identification of the anti-idiotype antibody. Approximately 5.5×10⁷ clones were quickly screened on just 10 plates using the ultra high throughput screening method while traditional methods would have required at least 550 plates to screen the same number of clones.

### 7.3 Example 3

Expressible Antibody Library Construction and Elimination of Non-Functional Clones

The plasmid pUCKA was generated to facilitate the cloning of a library of scFv with both 3′- FLAG and HIS6 epitope tags ligated to the polynucleotide encoding the β-lactamase gene (provides ampicillin/carbenicillin resistance). Several scFvs cloned with or without a stop codon demonstrated that only those clones lacking a stop codon were carbenicillin resistant. An entire library was cloned into the pUCKA vector and the number of non-functional clones prior to selection was found to be about 25%. A phage library constructed after selection to remove clones encoding a non-functional protein was found to have a complexity of more then 5×10⁸.

Construction of Expression Vector pUCKA: The vector pUCKA was derived from pUC19. The prime pairs KanaFor/KanaRev, pUCFor/EcoRIRev, and pUCRev/EcoRIFor were utilized to amplify the kanamycin gene and the pUC19 backbone with pET-27b (Novagen) and pUC19 as template, respectively. The three PCR fragments were gel-purified and assembled by overlapping PCR using primers EcoRIFor/EcoRIRev. The PCR product was digested by EcoRI, self-ligated, and transformed into XL1-Blue under the selection of kanamycin to generate vector pUCK (not shown), which β-lactamase gene was replaced by kanamycin. The polylinker, including a ribosome binding site, a p3 leader sequence, a Flag-tag, and a His-6-tag was amplified from phage expression vector pMD102 with primer HindIIIFor/EBNSRev and cloned into the HindIII/EcoRI site to make vector pUCK-1. The β-lactamase gene without start codon, ATG, was amplified from pUC19 using primers AmpFor/AmpRev and cloned into SpeI/EcoRI sites of pUCK-1 to create vector pUCKA. See Table 1 for primer sequences.

TABLE 1

Primer Sequences

| | | |
|---|---|---|
| Primer | Sequence | SEQ ID NO: |

| | | |
|---|---|---|
| pUCRev | 5′-ACTCTTCCTTTTTCAATATTATTGAAGC-3′ | 7 |
| Kanafor | 5′-GCTTCAATAATATTGAAAAAGGAAGAGTATGAGCCA | 8 |
| | TATTCAACGGGAAAC-3′ | |
| KanaRev | 5′-GAAAAACTCATCGAGCATCAAATGAAAC-3′ | 9 |
| pUCFor | 5′-GTTTCATTTGATGCTCGATGAGTTTTTCTAACTGTCA | 10 |
| | GACCAAGTTTACTC-3′ | |
| EcoRIFor | 5′-ACCGAGCTCGAATTCACTGGCCGTC-3′ | 11 |
| EcoRIRev | 5′-GACGGCCAGTGAATTCGAGCTCGGT-3′ | 12 |
| HindIIIFor | 5′-ATTACGCCAAGCTTTGGAGCCTTTTTTTTGGAGATT | 13 |
| | TTCAACGTGAAAAAATTATTATTCGCAAT-3′ | |
| EBNSRev | 5′-CAGTGAATTCTTAGCTAGCACTAGTATGGTGATGG | 14 |
| | TGATGGTGTGC-3′ | |
| AmpFor | 5′-CACCATACTAGTGGGGGCGGAAGTATTCAACATTT | 15 |
| | CCGTGTC-3′ | |
| AmpRev | 5′-GCCAGTGAATTCTTAGCGCGCTAGCTTACCAATGC | 16 |
| | TTAATCAGTGAGGCA-3′ | |

Clone scFv F9, LX2, EA20, and EA44: The polynucleotides encoding several scFvs designated F9, LX2, EA20, and EA44 with or without stop codon at their C-terminal ends were excised from pETHis, a scFv expression vector under the control of T7 promoter, cloned into the Sfi I sites of pUCKA, transformed into XL1-Blue, and spread on LB-agar/kananmycin plate containing 30 μg/ml kanamycin. The colonies were picked up and inoculated into LB/2XYT medium with or without carbenicillin at 100 μg/ml final concentration. Only these clones without a stop codon at the end of the scFv gene can survive under the selection of carbenicillin (data not shown). Based on this data, this vector can be harnessed to remove antibody gene with an undesirable stop codon or frame-shift from the antibody library. The growth rate of these clones expressing an scFv without stop codon was also evaluated at different concentration of carbenicillin (see Table 2).

TABLE 2
Growth Rates of Clones Expressing
scFv Molecules Without Stop Codons

| | 1600 | 800 | 400 | 200 | 100 | 50 |
|---|---|---|---|---|---|---|
| | μg/ml | μg/ml | μg/ml | μg/ml | μg/ml | μg/ml |
| | (Carb) | (Carb) | (Carb) | (Carb) | (Carb) | (Carb) |
| 7 hrs | | | | | | |
| pUC19 | 3.36 | 3.31 | 3.37 | 3.67 | 3.51 | 3.94 |
| LX2 | 0 | 0 | 0.3 | 1.51 | 3.96 | 3.99 |
| EA20 | 0 | 0 | 1.04 | 2.16 | 3.31 | 3.29 |
| EA44 | 0 | 0 | 0.58 | 1.85 | 3.76 | 3.98 |
| F9 | 0 | 0 | 0.07 | 0.66 | 2.45 | 3.21 |
| Over | | | | | | |
| night | | | | | | |
| pUC19 | 5.33 | 6.25 | 6.19 | 6.12 | 6.12 | 6.09 |
| LX2 | 0 | 0 | 1.25 | 6.13 | 6.24 | 6.20 |
| EA20 | 0 | 0 | 3.7 | 6.19 | 5.99 | 6.04 |
| EA44 | 0 | 0 | 4.96 | 6.06 | 5.81 | 5.98 |
| F9 | 0 | 0 | 0.41 | 4.29 | 5.99 | 5.95 |

Construction of scFv Expression Library: The scFv gene library in original phage expression vector (see Example 1, supra) with 2×10⁹ members was digested with Sfi I, gel-purified on agarose, and ligated into pUCKA vector that had been cut with the same restriction enzyme. The ligated products were electroporated into Escherichia coli XL1-Blue (a tetracycline resistant strain) competent cells to yield a diversity of ˜5×10⁹ independent transformants. After electroporation, cells were plated on LB agar containing 2% glucose, 50 μg/ml kanamycin, and 20 μg/ml tetracycline in 50 dishes (150 mm×10 mm; Nunc) and incubated overnight at 30° C. The clones were scraped off the plates into 300 ml of 2XYT medium. Inoculate 20 ml of the scraped bacterium into 1 liter of 2XYT medium, containing 100 μg/ml carbenicillin, 50 μg/ml kanamycin, and 2% glucose. The cells was grown at 37° C. for 4-6 hour with shaking to remove these antibody genes with frame shift or stop codon in the library for expressible antibody library construction. The glycerol was subsequently added into the rest of the bacterium at the final concentration of 10% and stored at −80° C.

Test of the system efficiency: 192 clones were picked up from library transformed LB-agar dishes after overnight growth at 30° C. and inoculated into 2 of 96 plates with 100 μl 2XYT medium, containing 100 μg/ml carbenicillin, 50 μg/ml kanamycin, and 2% glucose. After growth at 37° C. for 8 hours with shaking, transfer 5 μl from each wells into four deep-well plates containing 0.5 ml 2XYT in each well, two without and two with carbenicillin at 100 μg/ml. The plates were grown at 37° C. overnight and growth (positive/negative) was score by direct observation. All the clones can grow very well without carbenicillin. However, only 75% (144 out of 192 clones) can survive under the selection of 100 μg/ml carbenicillin.

Construction of expressible phase antibody expression library: The plasmid was extracted from bacterial library survived under the selection of 100 μg/ml carbenicillin by using the Maxi plasmid isolation kit (Qiagen). The expressible scFv library genes were digested with Sfi I, gel-purified, and ligated into phage expression vector pMD102 that was also cut by Sfi I. The ligated mixture, scFv library, was electroporated into XL1-Blue competent cell using 15 cuvettes (Bio-Rad), mixed with 2XYT top-agar, plated on 40 LB agar dishes (150 mm×10 mm; Nunc), and incubated at 30° C. overnight. The diversity of this library was more than 5×10⁸, counted as plaque number. The phage library was eluted from the top-agar with 200 ml of phage elution buffer (10 mM Tris-HCl, 150 mM NaCl, pH 7.5). PEG and NaCl were added to the final concentration of 4% and 3%, respectively, to precipitate the phage. The phage was resuspended in PBS buffer containing 8% of glycerol, aliquoted, and stored at −80° C.

7.3.1 Results

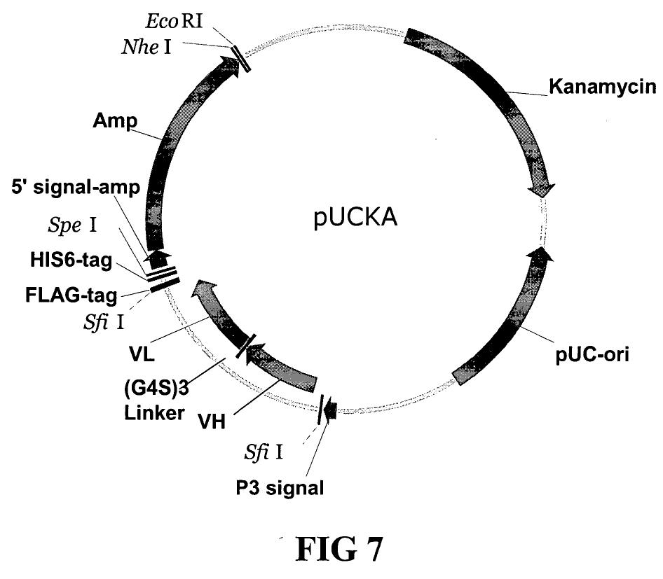

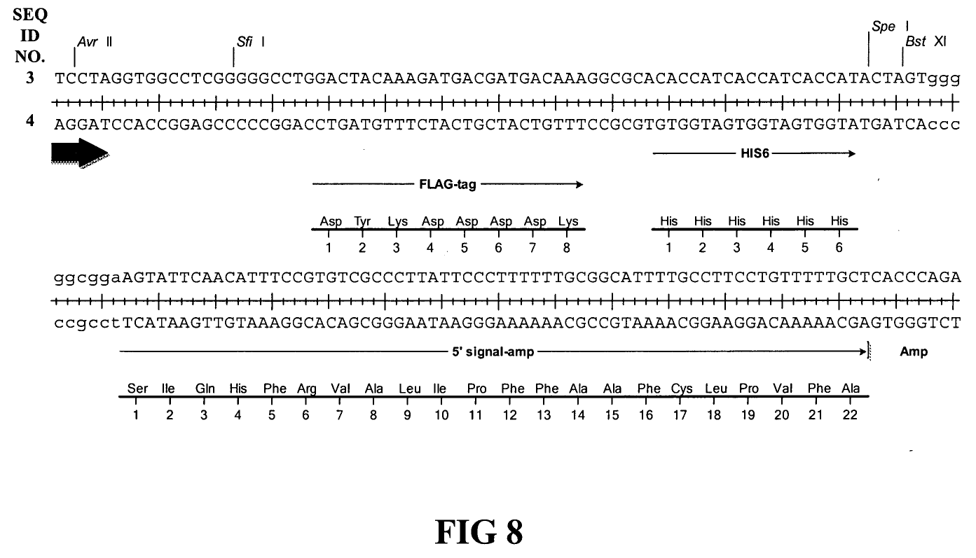

Using standard molecular cloning techniques the plasmid pUCKA was generated to facilitate the generation of a library of polynucleotides encoding molecules ligated to a polynucleotide encoding a selectable marker. FIG. 7 is a plasmid map and FIG. 8 details the nucleotide sequence surround the library cloning site. Key features of pUCKA include, two drug selection markers: a kanamycin resistance gene for selection/maintenance of cells containing the vector and a β-lactamase gene (provides ampicillin/carbenicillin resistance) for selection to remove clones expressing nonfunctional molecules, an origin of replication, a promoter and signal sequence 5′ of a cloning site (Sfi I) and 3′ of the cloning site are a FLAG and HIS6 epitope tags ligated in frame to the β-lactamase gene. It should be noted that the β-lactamase gene is lacking a start codon, thus only transcripts encoding a functional fusion protein will result in cells expressing β-lactamase. Thus, any polynucleotide cloned into the Sfi I site that is not in the correct reading frame or contains a mutation resulting in a stop codon or contains a frameshift mutation will not generate a transcript encoding a functional fusion protein (i.e., express a functional β-lactamase) and will not be resistance to ampicillin/carbenicillin.

To test the vector several scFvs were cloned into the Sfi I site (in the proper reading frame) with or without a stop codon. Only those clones encoding an scFv without a stop codon should generate transcripts encoding a functional fusion protein. Indeed, only those clones encoding an scFv lacking a stop codon were able to grow in the presence of carbenicillin. The growth rate of several clones encoding an scFv lacking a stop codon were examined (see Table 2). At lower concentrations of carbenicillin (50-100 μg/ml) little difference was seen among the clones however, at higher concentrations (200-400 μg/ml) several clones grew more slowly, probably reflecting the lower levels of expression of those clones. At even higher concentrations of carbenicillin non of the scFv clones grew. These data indicated that to avoid loss of low expressing clones selection conditions it may be necessary to use a minimal concentration of a negative selection agent such as a drug or it may be necessary to increase the time of selection if an auxotrophic selection marker were used.

To determine the abundance of clones expressing a nonfunctional molecule (i.e., will not generate a transcript encoding a functional fusion protein when cloned into pUCKA) an entire library was cloned into the pUCKA vector and transformed into E. coli and grown in kanamycin to select for transformed cells. 192 individual colonies were isolated and grown with or without carbenicillin at 100 μg/ml. Only 144 out of 192 grew in the presence of carbenicillin indicating that the number of non-functional clones prior to selection is about 25%. Thus a significant reduction in nonfunctional clones can be achieved by generating a library in a vector such as pUCKA and selecting only for those clones encoding a functional molecule.

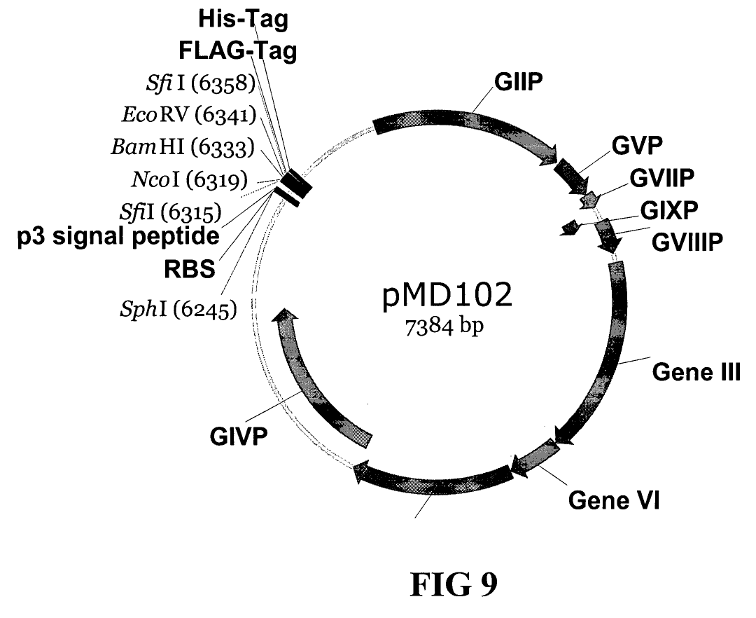

The library cloned into pUCKA was then grown in the presence of cabenicillin to eliminate nonfunctional clones. Following selection a phage library was constructed by subcloning the Sfi I fragment containing the scFv gene into the plasmid pMD102 (see FIG. 9). The resulting phage library was found to have a complexity of more then 5×10⁸.

### 7.4 Example 4

Construction of a Naïve Human scFv Expression Library Directly into pUCKA

Production of Naïve Human scFv Expression Library in pUCK4: Generation of a Human scFv library for selection may be performed essentially as described in Example 1 except that the scFvs will be cloned directly into pUCKA. Briefly, a human mRNA from lymph nodes and spleen tissues is reverse transcribed and the V_{H} and V_{L} sequences are amplified by PCR. Overlap PCR is then utilized to join the V_{H} and V_{L} sequences forming an scFv gene. The scFv genes are then ligated into the pUCKA expression vector at the Sfi I restriction site and transformed into E. coli. The transformed E. coli may be grown under conditions permissive for growth of all clones (e.g., in media comprising kanamycin but not comprising ampicillin/carbenicillin) or may be grown under selection conditions for growth of only those clones encoding a functional scFv ligated to the β-lactamase gene (e.g., in media comprising both kanamycin and ampicillin/carbenicillin or just ampicillin/carbenicillin alone). In the event that the resulting transformed E. coli cells are grown under permissive conditions, a portion or all of the resulting culture may then be grown under selection conditions. Some specific antibiotic concentrations are detailed in examples 1 and 3. The resulting culture may be screened or may be stored (e.g., as a frozen glycerol stock) for use at a later date.

For screening purposes it may be desirable to subclone the scFv fragments after selection for those clones which can grow in ampicillin/carbenicillin (i.e., selection of those clones encoding a functional scFv fused to the β-lactamase gene) into an alternate vector such as those suitable for phage expression or phage display. To facilitate the use of the high throughput screening method described above, the scFv fragments are subcloned into a vector suitable for phage expression such as pMD102.

### 7.5 Example 5

Additional Expression Vectors

Construction of Expression Vector Additional Expression Vectors: Additional expression vectors may be derived from pUC19 or other vectors in a manner analogous to those used for the construction of pUCKA. Alternatively, additional expression vectors may be generated de novo by the ligation of polynucleotides encoding desired features. Cloning methods useful for the production of additional expression vectors are well known in the art. See, for example, Current Protocols in Molecular Biology, F. M. Ausubel et al., ed., John Wiley & Sons (Chichester, England, 1998) and Molecular Cloning: A Laboratory Manual, 3nd Edition, J. Sambrook et al., ed., Cold Spring Harbor Laboratory Press (Cold Spring Harbor, N.Y., 2001).

Additional vectors generated may differ from pUCKA in one or more features including but not limited to, epitope tags, cloning sites for insertion of polynucleotides encoding a library of molecules, selection marker for fusion of polynucleotides encoding a library of molecules, origin of replication, signal sequences, promoters, additional selection marker for maintenance/selection of cells comprising an expression vector, other specialized components necessary for expression and/or maintenance of the vector in a cell.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

1. A method for the ultra high throughput screening of a library of binding molecules to identify a binding molecule having selective affinity for a ligand, comprising the steps of:
a. plating the library of binding molecules at a density of between 10 and 15,000 clones per mm²;
b. immobilizing the population of binding molecules to a solid support;
c. contacting said immobilized library with at least one ligand; and
d. identifying at least one binding molecule which selectively binds to at least one of said ligands.

2. The method of claim 1, wherein said binding molecules are soluble.

3. The method of claim 1, wherein said binding molecules are selectively immobilized.

4. The method of claim 1, wherein said library of binding molecules is produced in an expression library.

5. The method of claim 4, wherein said expression library is an antibody library.

6. The method of claim 5, wherein said antibody library expresses an antibody fused to an immobilization domain.

7. The method of claim 1, wherein said ligand is soluble

8. The method of claim 7, wherein said ligand is a polypeptide.

9. The method of claim 8, wherein said polypeptide is fused to a detection domain.

10. The method of claim 1, wherein the library of binding molecules is plated at a density of between 1000 and 5,000 clones per mm².

11. A method to enhance the detection of the interaction of one or more binding molecules with at least one ligand, comprising the steps of:
a. Immobilizing the binding molecule(s);
b. Contacting immobilized binding molecule(s) with at least one ligand; and
c. Detecting the interaction of the at least one ligand with the immobilized binding molecule(s).

12. The method of claim 11, wherein said ligand is soluble.

13. The method of claim 12, wherein said ligand is fused to a detection domain.

14. A method of generating an expression library comprising the steps of:
a. generating, in an expression vector, a library of clones comprising polynucleotides encoding molecules ligated to a polynucleotide encoding a selectable marker useful for the selection of clones expressing functional molecules, and
b. growing the library of clones generated in (a) under conditions which select for clones expressing functional molecules.

15. The method of claim 14, further comprising the step of: subcloning the polynucleotides encoding functional molecules from the selected library of step (b) into an alternate vector useful for the identification and/or isolation of particular desired functional clones.

16. The method of claim 14, wherein said expression vector is an E. coli expression vector.

17. The method of claim 16, wherein said E. coli expression vector is pUCKA.

18. The method of claim 14, wherein said library of clones comprises polynucleotides encoding a population of binding molecules.

19. The method of claim 18, wherein said population binding molecules are antibodies.

20. The method of claim 15, wherein said alternate vector is a phage expression vector.
